(19) United States
(12) Patent Application Publication
(10) Pub. No.: US 2025/0048041 A1
(43) Pub. Date: Feb. 6, 2025

(54) PROCESSING AUDIO SIGNALS FROM UNKNOWN ENTITIES

(71) Applicant: ORCAM TECHNOLOGIES LTD., Jerusalem (IL)

(72) Inventors: Roi NATHAN, Jerusalem (IL); Tal ROSENWEIN, Herzliya (IL); Amnon SHASHUA, Mevaseret Tsiyon (IL)

(21) Appl. No.: 18/924,025

(22) Filed: Oct. 23, 2024

Related U.S. Application Data
(63) Continuation-in-part of application No. 18/398,948, filed on Dec. 28, 2023.
Application No. 18/398,948 is a continuation of application No. PCT/IL2023/050609, filed on Jun. 13, 2023.
(60) Provisional application No. 63/351,454, filed on Jun. 13, 2022.

(51) Int. Cl. H04R 25/00

(52) U.S. Cl. CPC H04R 25/505; H04R 25/43; H04R 25/558; H04R 2225/41; H04R 2225/43; H04R 2225/55

(57) ABSTRACT

A method, product and apparatus comprising: capturing a first noisy audio signal from an environment of a user; generating a first enhanced audio signal by implementing a first processing mode to apply sound separation to the first noisy audio signal, whereby at least one sound from an entity is filtered out from the first enhanced audio signal; outputting to the user the first enhanced audio signal; in response to a user indication, changing the first processing mode to a second processing mode; capturing a second noisy audio signal from the environment; generating a second enhanced audio signal by implementing the second processing mode to not apply the sound separation, whereby sounds from a plurality of entities comprising the entity remain unfiltered in the second enhanced audio signal; and outputting to the user the second enhanced audio signal.

### CROSS-REFERENCE TO RELATED APPLICATION

This application is a Continuation In Part of and claims the benefit of U.S. patent application Ser. No. 18/398,948, entitled “MAPPING SOUND SOURCES IN A USER INTERFACE”, filed Dec. 28, 2023, which is a continuation of PCT Patent Application No. PCT/IL2023/050609, entitled “PROCESSING AND UTILIZING AUDIO SIGNALS”, filed Jun. 13, 2023, which, in turn, claims the benefit of Provisional Patent Application No. 63/351,454, entitled “A Hearing Aid System”, filed Jun. 13, 2022, which are hereby incorporated by reference in their entirety without giving rise to disavowment.

### TECHNICAL FIELD

The present disclosure relates to processing audio signals in general, and to processing and utilizing audio signals from a noisy environment of a user for a hearable device, in particular.

### BACKGROUND

A hearing aid is a device designed to improve hearing by making sound audible to a person with hearing loss or hearing degradation. Hearing aids are used for a variety of pathologies including sensorineural hearing loss, conductive hearing loss, and single-sided deafness. Hearing aids are classified as medical devices in most countries, and regulated by the respective regulations. Hearing aid candidacy is traditionally determined by a Doctor of Audiology, or a certified hearing specialist, who will also fit the device based on the nature and degree of the hearing loss being treated.

Hearables, on the other hand, are over-the-counter ear-worn devices that can be obtained without a prescription, and without meeting specialists. Hearables may typically comprise speakers to convert analog signals to sound, a Bluetooth™ Integrated Circuit (IC) to communicate with other devices, sensors such as biometric sensors, microphones, microphones, or the like. Other over-the-counter devices may comprise a smart television, smartphone, smart watch, smart microphones (mics), smart windows, or the like.

### BRIEF SUMMARY

One exemplary embodiment of the disclosed subject matter is a method comprising: capturing a first noisy audio signal from an environment of a user, the user having at least one hearing device used for providing audio output to the user; generating, based on the first noisy audio signal, a first enhanced audio signal, said generating the first enhanced audio signal is performed by implementing a first processing mode, the first processing mode is configured to apply sound separation to the first noisy audio signal, whereby at least one sound from an entity is filtered out from the first enhanced audio signal; outputting to the user, via the at least one hearing device, the first enhanced audio signal; in response to a user indication, changing a processing mode from the first processing mode to a second processing mode; capturing a second noisy audio signal from the environment; generating, based on the second noisy audio signal, a second enhanced audio signal, said generating the second enhanced audio signal is performed by implementing the second processing mode, the second processing mode is configured not to apply the sound separation, whereby sounds from a plurality of entities in the environment remain unfiltered in the second enhanced audio signal, the plurality of entities comprises the entity; and outputting to the user, via the at least one hearing device, the second enhanced audio signal.

Optionally, the user indication comprises a selection by the user of a control on a mobile device of the user for a time period, wherein the selection causes the first processing mode to be switched with the second processing mode during the time period, wherein in response to the user releasing the selection of the control, the method comprises changing the processing mode from the second processing mode back to the first processing mode.

Optionally, before the selection of the control, the first enhanced audio signal incorporated voices of a first number of entities; during the selection of the control, the second enhanced audio signal incorporated voices of a second number of entities, the second number of entities greater than the first number of entities; and after the selection of the control, a subsequent enhanced audio signal that is outputted to the user incorporated the voices of the first number of entities.

Optionally, the second number of entities comprises at least a sum of: a number of one or more unfiltered entities that were activated by the user, a number of one or more muted entities that were muted by the user, and a number of unknown entities, wherein the subsequent enhanced audio signal excludes sounds of the one or more muted entities.

Optionally, said generating the first enhanced audio signal comprises: extracting a first separate audio signal from the first noisy audio signal to represent a first entity of the plurality of entities, said extracting is performed based on a first acoustic fingerprint of the first entity; extracting a second separate audio signal from the first noisy audio signal to represent a second entity of the plurality of entities, said extracting is performed based on a second acoustic fingerprint of the second entity; and combining the first and second separate audio signals to generate the first enhanced audio signal.

Optionally, the entity is muted by the user, wherein the first noisy audio signal comprises a sound of the entity, wherein the first enhanced audio signal is absent of the sound of the entity, and the second enhanced audio signal incorporates the sound of the entity.

Optionally, said generating the first enhanced audio signal comprises: extracting a first separate audio signal from the first noisy audio signal to represent a first entity of the plurality of entities, said extracting is performed based on a direction of arrival associated with the first entity; extracting a second separate audio signal from the first noisy audio signal to represent a second entity of the plurality of entities, said extracting is performed based on a direction of arrival associated with the second entity; and combining the first and second separate audio signals to obtain the first enhanced audio signal.

Optionally, said generating the first enhanced audio signal comprises: extracting a first separate audio signal from the first noisy audio signal to represent a first entity of the plurality of entities, said extracting is performed based on a first acoustic fingerprint of the first entity; extracting a second separate audio signal from the first noisy audio signal to represent a second entity of the plurality of entities, said extracting is performed based on a direction of arrival associated with the second entity; and combining the first and second separate audio signals to obtain the first enhanced audio signal.

Optionally, said generating the first enhanced audio signal comprises: extracting a first separate audio signal from the first noisy audio signal to represent a first entity of the plurality of entities, said extracting is performed based on a descriptor of the first entity, wherein said extracting is performed by a machine learning model that is trained to extract audio signals according to textual or vocal descriptors; and generating the first enhanced audio signal to incorporate the first separate audio signal.

Optionally, the user indication is identified automatically without explicit user input, wherein the user indication comprises at least one of: a head movement of the user, or a sound direction of the user.

Optionally, the user is surrounded by one or more unfiltered entities of the plurality of entities, the first processing mode is configured to include sounds emitted by the one or more unfiltered entities in the first enhanced audio signal, wherein the user indication is indicative of the user directing attention to a direction that does not match directions of any of the one or more unfiltered entities.

Optionally, the user indication is identified automatically based on at least one of: a motion detector, an optical tracking system, and a microphone array.

Optionally, the processing mode is changed back from the second processing mode to the first processing mode in response to a second user indication, the second user indication comprises at least one of: a second head movement of the user, and a second sound direction of the user.

Optionally, the user indication is identified automatically without explicit user input, wherein the user indication comprises an automatic semantic analysis of a transcript of user speech.

Optionally, the processing mode is changed back from the second processing mode to the first processing mode in response to a second user indication, the second user indication comprises a second semantic analysis of subsequent user speech.

Optionally, the user indication is a vocal command or a manual interaction with the hearing device.

Optionally, the method comprises performing a smooth transition between the first processing mode and the second processing mode during an overlapping cross-fade period, wherein during the cross-fade period, a volume of the first enhanced audio signal is gradually decreased while a volume of the second enhanced audio signal is gradually increased, whereby portions of the first and second enhanced audio signals are briefly heard together during the cross-fade period.

Optionally, the user indication comprises a first manual selection of the second processing mode via the mobile device, wherein the processing mode is changed back from the second processing mode to the first processing mode in response to a second manual selection of the first processing mode via the mobile device.

Optionally, the second processing mode is configured to remove a background noise from the second noisy audio signal without applying the sound separation.

Optionally, the user indication comprises a selection of an object in a map view presented by the mobile device, wherein the object represents the entity, wherein a relative location of the object with respect to the mobile device is determined based on a direction of arrival associated with the entity.

Another exemplary embodiment of the disclosed subject matter is a computer program product comprising a non-transitory computer readable medium retaining program instructions, which program instructions, when read by a processor, cause the processor to perform: capturing a first noisy audio signal from an environment of a user, the user having at least one hearing device used for providing audio output to the user; generating, based on the first noisy audio signal, a first enhanced audio signal, said generating the first enhanced audio signal is performed by implementing a first processing mode, the first processing mode is configured to apply sound separation to the first noisy audio signal, whereby at least one sound from an entity is filtered out from the first enhanced audio signal; outputting to the user, via the at least one hearing device, the first enhanced audio signal; in response to a user indication, changing a processing mode from the first processing mode to a second processing mode; capturing a second noisy audio signal from the environment; generating, based on the second noisy audio signal, a second enhanced audio signal, said generating the second enhanced audio signal is performed by implementing the second processing mode, the second processing mode is configured not to apply the sound separation, whereby sounds from a plurality of entities in the environment remain unfiltered in the second enhanced audio signal, the plurality of entities comprises the entity; and outputting to the user, via the at least one hearing device, the second enhanced audio signal.

Yet another exemplary embodiment of the disclosed subject matter is an apparatus comprising a processor and coupled memory, said processor being adapted to perform: capturing a first noisy audio signal from an environment of a user, the user having at least one hearing device used for providing audio output to the user; generating, based on the first noisy audio signal, a first enhanced audio signal, said generating the first enhanced audio signal is performed by implementing a first processing mode, the first processing mode is configured to apply sound separation to the first noisy audio signal, whereby at least one sound from an entity is filtered out from the first enhanced audio signal; outputting to the user, via the at least one hearing device, the first enhanced audio signal; in response to a user indication, changing a processing mode from the first processing mode to a second processing mode; capturing a second noisy audio signal from the environment; generating, based on the second noisy audio signal, a second enhanced audio signal, said generating the second enhanced audio signal is performed by implementing the second processing mode, the second processing mode is configured not to apply the sound separation, whereby sounds from a plurality of entities in the environment remain unfiltered in the second enhanced audio signal, the plurality of entities comprises the entity; and outputting to the user, via the at least one hearing device, the second enhanced audio signal.

One exemplary embodiment of the disclosed subject matter is a method comprising: determining that a user has an intention to hear an unknown entity, the user utilizing a hearing system that includes at least one hearing device for providing audio output to the user, the hearing system is configured to perform a sound separation and to filter-out sounds by any non-activated entity, wherein in case an entity is activated, a sound of the entity is configured to be included in the audio output that is provided to the user by the hearing system, thereby enabling the user to hear the sound of the entity; determining an angle between the user and the unknown entity; capturing a noisy audio signal from an environment of the user; generating, based on the angle, an enhanced audio signal that comprises a sound of the unknown entity, said generating the enhanced audio signal comprises applying the sound separation to extract a separate audio signal that represents the unknown entity from the noisy audio signal, wherein said generating the enhanced audio signal comprises incorporating the separate audio signal in the enhanced audio signal; and outputting to the user, via the at least one hearing device, the enhanced audio signal.

Optionally, the method comprises generating, based on the angle, an acoustic signature of the unknown entity; and extracting the separate audio signal based on the acoustic signature.

Optionally, the method comprises extracting the separate audio signal based on a direction of arrival of the sound of the unknown entity.

Optionally, said generating the enhanced audio signal uses one or more models to extract the separate audio signal from the noisy audio signal, the one or more models comprise at least one of: a generative model, a discriminative model, or a beamforming model.

Optionally, said determining that the user has the intention to hear the unknown entity is based on an analysis of activity of the user without an explicit instruction from the user, wherein the analysis of the activity of the user comprises at least one of: identifying a head movement of the user, or identifying a change in a sound direction of the user.

Optionally, the angle between the user and the unknown entity is determined based on an angle of the head movement or based on the sound direction.

Optionally, determining that the user has the intention to hear the unknown entity is performed automatically without explicit user input, wherein the user indication comprises an automatic semantic analysis of a transcript of user speech.

Optionally, prior to said determining that the user has the intention to hear the unknown entity, the method comprises generating an acoustic signature of the unknown entity based on one or more dominant directions of arrival of sounds.

Optionally, said determining that the user has the intention to hear the unknown entity is based on explicit user input, the user input comprises one of: an indication of the angle between the user and the unknown entity via a mobile device of the user, and an interaction of the user with the at least one hearing device.

Optionally, said determining that the user has the intention to hear the unknown entity is based explicit user input to a mobile device of the user, the explicit user input comprises a selection of a relative location between the user and the unknown entity via a map view that is rendered on the mobile device.

Optionally, the method comprises displaying the map view to the user via the mobile device, the map view depicting locations of one or more entities relative to a location of the mobile device; receiving, via the mobile device, the selection of the relative location; generating an acoustic fingerprint of the unknown entity based on a direction of arrival of the sound of the unknown entity; and processing, based on the acoustic fingerprint, the noisy audio signal to extract the separate audio signal.

Optionally, said determining that the user has the intention to hear the unknown entity is based on a manual interaction of the user with the hearing device, wherein the sound of the unknown entity is identified based on a time of the manual interaction.

Another exemplary embodiment of the disclosed subject matter is a computer program product comprising a non-transitory computer readable medium retaining program instructions, which program instructions, when read by a processor, cause the processor to perform: determining that a user has an intention to hear an unknown entity, the user utilizing a hearing system that includes at least one hearing device for providing audio output to the user, the hearing system is configured to perform a sound separation and to filter-out sounds by any non-activated entity, wherein in case an entity is activated, a sound of the entity is configured to be included in the audio output that is provided to the user by the hearing system, thereby enabling the user to hear the sound of the entity; determining an angle between the user and the unknown entity; capturing a noisy audio signal from an environment of the user; generating, based on the angle, an enhanced audio signal that comprises a sound of the unknown entity, said generating the enhanced audio signal comprises applying the sound separation to extract a separate audio signal that represents the unknown entity from the noisy audio signal, wherein said generating the enhanced audio signal comprises incorporating the separate audio signal in the enhanced audio signal; and outputting to the user, via the at least one hearing device, the enhanced audio signal.

Yet another exemplary embodiment of the disclosed subject matter is an apparatus comprising a processor and coupled memory, said processor being adapted to perform: determining that a user has an intention to hear an unknown entity, the user utilizing a hearing system that includes at least one hearing device for providing audio output to the user, the hearing system is configured to perform a sound separation and to filter-out sounds by any non-activated entity, wherein in case an entity is activated, a sound of the entity is configured to be included in the audio output that is provided to the user by the hearing system, thereby enabling the user to hear the sound of the entity; determining an angle between the user and the unknown entity; capturing a noisy audio signal from an environment of the user; generating, based on the angle, an enhanced audio signal that comprises a sound of the unknown entity, said generating the enhanced audio signal comprises applying the sound separation to extract a separate audio signal that represents the unknown entity from the noisy audio signal, wherein said generating the enhanced audio signal comprises incorporating the separate audio signal in the enhanced audio signal; and outputting to the user, via the at least one hearing device, the enhanced audio signal.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an exemplary flowchart diagram of a method, in accordance with some exemplary embodiments of the disclosed subject matter;

FIG. 2A shows an exemplary flowchart diagram of a method, in accordance with some exemplary embodiments of the disclosed subject matter;

FIG. 2B shows an exemplary map view, in accordance with some exemplary embodiments of the disclosed subject matter;

FIGS. 3A-3B show exemplary flowchart diagrams of a methods, in accordance with some exemplary embodiments of the disclosed subject matter;

FIG. 4A shows a schematic illustration of an exemplary environment in which the disclosed subject matter may be utilized, in accordance with some exemplary embodiments of the disclosed subject matter; and

FIG. 4B shows an exemplary scenario of utilizing the disclosed subject matter, in accordance with some exemplary embodiments of the disclosed subject matter.

### DETAILED DESCRIPTION

One technical problem dealt with by the disclosed subject matter is enhancing an intelligibility, clarity, audibility, or the like, of one or more entities that a user wishes to hear, e.g., while reducing a listening effort and/or a cognitive load of the user. For example, the user may be located in a noisy environment, may be conversing with multiple people, or the like, and may desire to hear clearly people of choice. In some exemplary embodiments, hearing devices such as hearing aids, hearables, audio devices, smartphones, or the like, may have limited functionalities. For example, users of both classical hearing aids and hearables may have limited control over which voices are amplified and conveyed to the user by the hearing devices, which may negatively affect an attempt of the user to participate in a conversation. As another example, classical hearing aids and hearables may not be capable of activating Active Noise Cancellation (ANC) and a transparency mode (e.g., for amplifying external sounds so that the user can hear their surroundings more clearly) simultaneously, which may adversely affect the hearing experience of the users. As another example, classical hearing aids and hearables may not enable a user to refrain from hearing specified unwanted sounds, such as speech of a person they do not like, or a speech of a person participating in a separate conversation. As another example, classical hearing aids and hearables may not enable a user to hear a specified sound in a reduced volume, such as in case of an excessively loud person. As another example, classical hearing aids and hearables may not enable a user to hear an amplified version of a first entity (e.g., human or non-human), while refraining from hearing a second entity. It may be desired to overcome such drawbacks, and provide users with a capability to selectively control which entities they hear, and a degree thereof.

Another technical problem dealt with by the disclosed subject matter is enhancing a user experience of using hearables. For example, it may be desired to provide a user with a user friendly or even seamless interface for controlling functionalities of the hearables, in order to enhance a human-machine interaction.

Yet another technical problem dealt with by the disclosed subject matter is enhancing a functionality of hearables, e.g., to enable an identification of entities that are producing sounds such as voices in the environment of the user.

Yet another technical problem dealt with by the disclosed subject matter is enabling hearables to retain background sounds of choice. Hearables may currently perform noise cancellation (e.g., active noise cancelation, passive filtering with sealed earplugs, or the like) to cancel out a background noise. In some cases, the background noises may comprise important noises such as a siren, and thus removing the background sound entirely may endanger the user. It may be desired to overcome such drawbacks.

Yet another technical problem dealt with by the disclosed subject matter is enhancing a user experience for individuals that do not necessarily have hearing impairments, a disturbing hearing loss, or the like. For example, the user experience of individuals with a slight hearing loss or no hearing impairment at all may be enhanced by enabling them to concentrate with lower effort on their conversation in a noisy environment. A human brain is able to focus auditory attention on a particular stimulus while filtering out a range of other stimuli, such as when focusing on a single conversation in a noisy room (the ‘cocktail party effect’). However, this brain effort can result with increased cognitive load and fatigue, caused by the attempt to filter out irrelevant sounds and focus on the desired stimulus, and may adversely impact the overall well-being of the user. In some cases, some people may have a difficulty in utilizing the Cocktail party effect, due to various reasons such as low concentration abilities, a slight hearing loss, or the like, and may struggle to discern and understand specific conversations in noisy environments, e.g., leading to increased stress and anxiety, sensory overload, reduced well-being, or the like. It may be desired to overcome such drawbacks, e.g., to enable people to filter out background sounds easily.

One technical solution provided by the disclosed subject matter is to separate and identify sounds in an environment of the user, so that the user will be enabled to regulate the selection of sounds that are provided to the user, and their volume. For example, the user may be enabled to mute or activate (e.g., opt-in) entities in the environment via a user interface of a mobile device of the user, and only be provided with audio channels that incorporate voices and/or sounds (both may be referred to hereinafter as ‘voices’) that are emitted from activated entities. As another example, entities in the environment may be activated or muted automatically and dynamically, such as according to predefined settings. In some exemplary embodiments, voices of activated or opted-in entities may be retained, amplified, or the like, and provided to the hearables of the user, e.g., to be emitted by speakers in the hearables and served to the user. In some exemplary embodiments, voices of muted entities and remaining background noise may not be separated from a captured audio signal, and may not be provided to the hearables of the user, thereby enhancing an audibility of desired sounds while reducing an audibility of undesired sounds.

It is noted that the term “hearables” may refer to any hearing device that enables audio to be provided to a user. For example, a hearing device may comprise hearables, earbuds, a loud speaker, a mobile telephone, a smartphone, a Personal Digital Assistant (PDA), a smartwatch, a tablet, a laptop, a Bluetooth speaker, an in-ear monitor, a cochlear implant, an assistive listening device, a virtual reality headset, or the like. It is further noted that while the term ‘voices’ typically refers to sounds produced by human entities, and the term ‘sounds’ typically refers to sounds produced by both human or non-human entities, this disclosure uses the terms interchangeably. For example, the term ‘voices’ may be used to describe sounds produced by non-human entities.

In some exemplary embodiments, at least two modes of operation may be enabled, a “several” mode and an “everyone” mode. In the ‘several’ mode, the disclosed technical solution may only provide voices of activated entities to the user. For example, in a ‘several’ mode, only voices of activated or opt-in entities may be extracted and provided to the user via the hearables. According to this example, sounds in an environment of the user may be captured, voices of activated entities may be extracted therefrom, combined, and transmitted to the user's hearables to be emitted to the user. In some cases, in addition to the ‘several’ mode, the user may be provided with all voices in the environment in an ‘everyone’ mode, in which background noise may be filtered out, removed, or the like, from the captured audio, without extracting voices of specified entities. In other cases, any other modes may be defined and/or used. For example, ‘several’ mode may be defined only for human voices, only for non-human sounds, for both sound types, or the like, and ‘everyone’ mode may be defined independently from ‘several’ mode only for human voices, only for non-human sounds, for both sound types, or the like. For example, ‘several’ mode may be set for non-human entities only, and ‘everyone’ mode may be set for human entities only, thus enabling various combinations of mode configurations. In some cases, an ‘everyone but the user’ mode may correspond to the ‘everyone’ mode, in which the user's own voice is attenuated.

In some exemplary embodiments, the user may be enabled to manually switch the operation mode via the mobile device, or any other user device that is accessible to the user. In some exemplary embodiments, the mobile device of the user may be configured to switch between modes automatically, based on the context, or the like. For example, in case no entities are activated, the ‘everyone’ mode may be used. As another example, in case no entities are activated, an ‘everyone but the user’ mode may be activated. As another example, in case no entities are activated, a number of default entities may be activated by default as part of the ‘several’ mode.

In some exemplary embodiments, in order to implement the ‘several’ mode, profiles of various entities may be generated to comprise acoustic fingerprints of the respective entities, contact information thereof, past communications of the user with the entities, or the like. For example, a profile of an entity may comprise a record of the entity, that may or may not comprise an identifier, an acoustic fingerprint, a textual description of the entity's voice (e.g., a baby, a male, a car horn), or the like. In some exemplary embodiments, acoustic fingerprints of entities may enable to identify the voices of the entities in a noisy audio signal swiftly, without requiring further analysis of the noisy signal. In some cases, textual descriptors of an entity's voice may be used in addition to or instead of acoustic fingerprints in order to extract the entity's voice from a noisy audio signal. In some exemplary embodiments, profiles of entities may be generated to comprise respective acoustic fingerprints, textual descriptors, or the like.

In some exemplary embodiments, acoustic fingerprints may be generated automatically, such as based on vocal communications with user contacts, vocal messages, instant messaging applications such as WhatsApp™, social network platforms, past telephone conversations of the user, synthesized speech, captured audio records from a current conversation, or the like. In some exemplary embodiments, acoustic fingerprints may be generated based on noisy audio signals and/or clean audio signals that incorporate the sound of the entity. As an example, a noisy audio record sent by a contact of the user may be analyzed to extract an acoustic fingerprint therefrom, e.g., potentially after applying noise removal, and the acoustic fingerprint may be stored in a profile of the contact. In some cases, a designated enrollment audio record, including a clean audio session of a target entity, may be utilized to generate an acoustic fingerprint of an entity. For example, an entity may comprise a human entity, a non-human entity, or the like. In some exemplary embodiments, an enrollment audio record may comprise an audio of the entity's sound that is a ‘clean’, e.g., has a minor background noise, has no background noise, is in a quiet environment, is known to belong to the entity, is recorded by microphones positioned in close proximity to the entity, or the like. In other cases, an enrollment audio record may comprise an audio of the entity's sound or synthesized speech, which may be obtained in a noisy environment.

In some exemplary embodiments, acoustic fingerprints may be generated from vocal records stored in an end device, from vocal records stored in a remote server, a combination thereof, or the like. In some exemplary embodiments, a database of acoustic fingerprints may be stored locally in the mobile device of the user, in a different user device, remotely in a cloud, in a server, a combination thereof, or the like. In some exemplary embodiments, acoustic fingerprints may be configured to uniquely identify a voice of an entity such as a person. In some exemplary embodiments, acoustic fingerprints may be utilized to identify and extract sounds of respective entities from audio signals that are captured in the environment of the user, thereby enabling to isolate and extract audio channels with such sounds. In some exemplary embodiments, one or more models may be trained to receive as input a signature of an entity, such as an acoustic fingerprint, and extract from a noisy audio signal a separate audio signal that corresponds to the acoustic fingerprint.

In other cases, any other models and techniques may be used for extracting separate audio signals of entities. For example, the models may comprise generative models, discriminative models, masked-based models, beamforming-based models, a combination thereof, or the like. In some cases, the models may be configured to operate in the time domain, in the spectral (frequency) domain, a combination thereof, or the like. As another example, instead of using an acoustic signature, or in addition thereto, a description-based model (e.g., an AI model) may be trained to obtain, as input, a descriptor of an entity (such as “a baby”, “car horn”, “male”, or the like), and extract sounds of respective entities from noisy audio signals that are captured in the environment of the user. For example, the training may be based on manual labeling of sounds. In some cases, the descriptors may be obtained as a textual string, a voice command, or the like, and the description-based model may extract and isolate a sound that corresponds to the description.

In some exemplary embodiments, one or more entities may be activated prior to a conversation, during a conversation with the desired entities, or at any other time. For example, the activation of entities may be performed manually by the user or automatically, e.g., when identifying a noisy environment that may reduce the audibility of the conversation. In some exemplary embodiments, a noisy environment may comprise a plurality of people participating in at least one conversation, loud background sounds, or the like. In some cases, one or more entities (e.g., predefined by the user, including for example people the user wishes to hear) may be activated as a default setting or starting point, and the user may adjust the activated entities as desired. For example, a non-human entity that produces siren sounds may be activated as default, to ensure that the user will hear emergency sounds.

In some exemplary embodiments, one or more sounds of interest may be activated as default, by the user, or the like, and may enable to preserve such sounds, if identified in the audio signal. For example, a list of potentially dangerous or important sounds, e.g., an alert sound, may be activated by default. In some exemplary embodiments, the captured audio may be analyzed to identify such sounds in the audio, such as using acoustic signatures of the sounds, using a multimodal audio-text representation model that is trained to represent or generate sounds that correspond to a textual description, an audio classification model, or the like. In some exemplary embodiments, identified sounds may be isolated and extracted from the audio and provided to the user's hearables, e.g., together with other isolated voices of other activated entities, by itself, or the like. In some exemplary embodiments, users may be enabled to dynamically adjust the list of sounds of interest, remove therefrom sounds, add thereto sounds, or the like.

In some exemplary embodiments, the user may utilize a mobile device (or any other suitable user device) for providing user input, obtaining information, controlling provided audio, activating or deactivating entities, or the like. In some exemplary embodiments, the user may utilize hearables, or any user device with speakers, for obtaining and hearing the audio output. In some exemplary embodiments, a user may activate an entity by selecting a user interface object that corresponds to the entity via the mobile device, by selecting a profile of the entity, by indicating the entity in any other way, or the like.

In some exemplary embodiments, in case a user activates a profile of an entity that lacks an acoustic fingerprint, an acoustic fingerprint may be dynamically generated for the profile, such as based on captured real time sounds from the respective entity. In case an entity has no profile, an acoustic signature may be obtained explicitly by the user, or implicitly, such as based on real time captured audio. For example, in case the entity emits sound within an environment of the user, audio in the environment may be recorded, and parts of the audio that are spoken by the entity may be clustered and used to generate an acoustic signature of the entity.

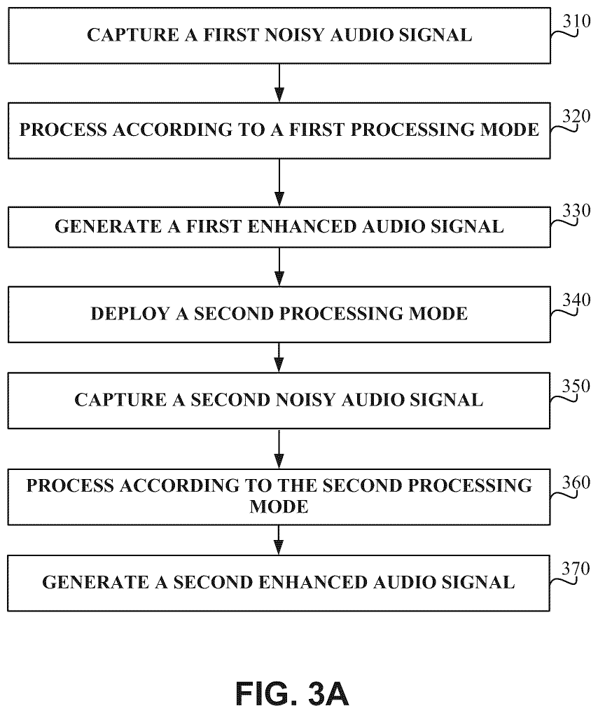

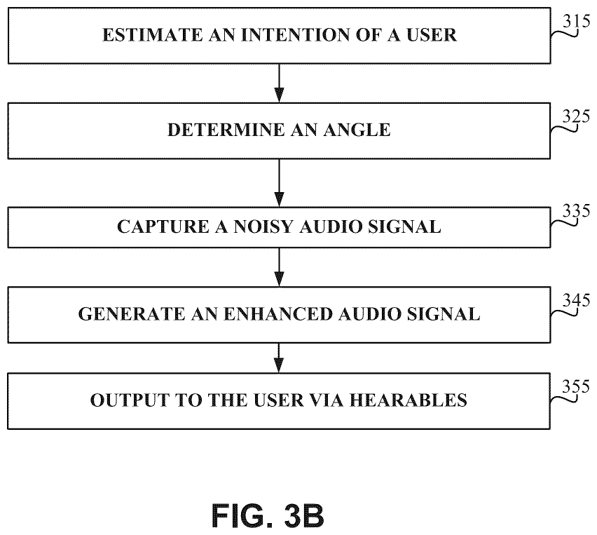

In some exemplary embodiments, users may be enabled to activate temporary entities for a temporary timeframe, e.g., according to the method of FIG. 3A. For example, the user may be conversing with friends in a restaurant, and the profiles of the friends being activated. The user may desire to hear a waiter for a short period of time, e.g., when the waiter arrives to take their order. In such cases, the user may not have a profile or fingerprint of the waiter, as the waiter may constitute a temporary entity that is not part of the user's conversation. In some exemplary embodiments, since the waiter is not known to the user, the mobile device of the user may not store or have access to acoustic fingerprints of the waiter, a profile of the waiter, or the like. The user may not necessarily want to generate a profile and/or fingerprint for the waiter, since the waiter may communicate with the user for a short period of time (e.g., less that a threshold) and may not be a permanent contact of the user. For example, the user may not encounter the waiter ever again, and thus may not want to store a profile for the waiter.

In some exemplary embodiments, one or more techniques may be used to activate temporary entities and enable users to hear, via the hearables, the temporary entities. For example, the user may perform a mode switch, and activate the ‘everyone’ mode via the mobile device, thereby enabling the user to hear all voices around him. After the waiter leaves, the user may reselect the ‘several’ mode, thereby excluding the voice of the waiter.

In some cases, in order to provide a more user-friendly and straightforward method for activating temporary entities, users may be able to dynamically activate a temporary entity through a dedicated control in the mobile device's user interface, or any other user device. In some exemplary embodiments, a ‘press and hold’ operation may be configured so that when the user presses and holds a control (e.g., a button) in the user interface, the mode of operation automatically switches to ‘everyone’ mode for the duration that the control is pressed or selected, and reverts to ‘several’ mode when the control is released or deselected. For example, the control may be designed in any shape, having any text (if any), and may be activated in any manner (voice control, button click, tap, or the like). In some exemplary embodiments, a ‘press and hold’ control may enable the user to easily hear temporary entities for short periods of time, without generating for them profiles, acoustic signatures, directions of arrival, or the like, and without being required to manually change modes twice for each temporary entity. For example, the control may be visible during the conversation, on the user interface of the mobile device, and the user may not be required to navigate or exit the user interface to reach the settings menu of the mobile device. In other cases, the control may be implemented on a hearable device of the user, such as by performing a specified gesture or interaction with the earbuds.

In some cases, in order to provide an automatic method for activating temporary entities without requiring any input from the user and any contact with the mobile device, users may be able to dynamically activate a temporary entity through on automatic motion detection of the user's motions. For example, the automatic motion detection may be performed without manual selections on the ‘press and hold’ control and without manual mode selections, thereby enhancing the user experience. In some exemplary embodiments, the user's motions and/or speech may be tracked using a variety of technologies, such as using a motion tracker, an accelerometer, an optical tracking system, a microphone array, a beamforming microphone system, an acoustic localization system, a sound triangulation system, a Direction of Arrival (DoA) measurer, a camera, infrared sensors, ultrasonic sensors, gyroscopes, LiDAR systems, a depth-sensing camera, facial recognition software, eye-tracking systems, electromyography (EMG) sensors, brain-computer interfaces (BCIs), or the like. For example, one or more trackers may be used to track the user's head movements, face direction, speech direction, or the like.

In some cases, one or more alternative automatic methods for activating temporary entities may be deployed. For example, temporary entities may be activated based on identified directions of arrival of voices. According to this example, sounds that arrive from a direction that does not correspond to an active entity (e.g., dominant sounds) may cause the mode of operation to change. As another example, temporary entities may be activated based on a sematic analysis of the user's speech. For example, a sematic analyzer may extract from the user's conversation indications of temporary entities, and change the mode of operation based thereon. As another example, temporary entities may be activated based on a descriptor provided by the user. For example, a user saying: “provide baby sounds” may cause a description-based model to extract baby sounds from the noisy audio signal, or to change the mode of operation to ‘everyone’ mode.

In some exemplary embodiments, based on the tracked user motions, the sematic analysis, the descriptor, or the like, an intention of the user may be estimated, classified, or the like. In some cases, the intention may be categorized into a first class for activating temporary entities or a second class for not activating temporary entities. For example, if the angle at which the user moves their head or speaks does not align with the angle of any activated entities, the user's intention to converse with a temporary entity may be identified. As another example, if the user's head movement is sharper or quicker than a specified threshold, this may indicate an intention to converse with a temporary entity. According to these examples, the mode of operation may automatically revert back to ‘several’ mode based on one or more subsequent user motions, such as in case the user's head returns to its previous position or direction, if no sound is detected from the angle of the temporary entity over a period of time, if a semantic analysis determines that the temporary entity left, or based on any other indication that the user's intention changed.

In some exemplary embodiments, one or more noisy audio signals in the user's environment may be captured continuously, periodically, or the like, and records of captured audio signals may be processed, such as in order to identify speech of activated entities in the audio. For example, acoustic fingerprints of activated entities may be matched with respective voices in a captured audio signal, and used to extract and generate separate audio signals for each identified entity. It is noted that an acoustic fingerprint may also identify sounds emitted by non-human entity, such as a sound emitted by a vehicle, a public address system, air condition, or the like. In some exemplary embodiments, a verification module may be utilized for double-checking that the extracted sounds are indeed emitted by the respective entities, and for eliminating any identification or separation errors that may occur. In some exemplary embodiments, the extracted sounds may be processed, combined, or the like, to obtain an enhanced audio signal, and the enhanced audio signal may be provided to the hearables of the user. In some cases, muted entities may be filtered out actively or passively. For example, as part of a passive filtration, the voices may not be extracted from the captured audio signal and thus may not be included in the enhanced audio signal that is conveyed to the user. As another example, as part of an active filtration of a muted entity's voice, a beamforming or learnable model may be used to attenuate audio arriving from the direction of arrival of the muted entity, a separate audio signal representing the entity's voice may be removed from the enhanced audio signal, or the like. The user's hearables may utilize active or passive noise cancellation, in order to reduce the level of sound from the environment that reaches the user.

In some exemplary embodiments, users may be enabled to dynamically activate or mute entities in the environment via the user interface, such as in response to changes in the environment, changes to the position of the user, changes in the preferences of the user, or the like. For example, a user may sit in a restaurant with two or more friends, and may desire to hear the friends, but the user may not desire to hear other people sitting nearby, other people sitting in separate tables, background music and noise, or the like. In this scenario, the acoustic fingerprints of the friends may be applied on noisy audio that is recorded in the restaurant, e.g., by microphones of the mobile device of the user, and may enable to isolate the friends' speech from the noisy audio. The isolated speech, which may be cleaned from undesired sounds, may or may not be amplified, and may be provided to the user's hearables. In case the user dynamically mutes an activated entity, e.g., a friend, the muted friend's speech may not be extracted and isolated any more, and may not be included in the enhanced signal that is provided to the user's hearables. In some cases, entities may be activated or muted automatically, such as based on whether or not they are estimated to be situated in the environment of the user, whether they are estimated to participate in the conversation the user is involved in, or the like, and the user may be able to adjust the automatic decisions.

In some exemplary embodiments, entities in the environment of the user may be presented in a map view, such as around a location of the user or a device associated with the user. It is noted that the location of the user may refer to a location of a user device that is adjacent to the user, a location of a mobile device held by the user, a location of a hearing device worn by the user, a microphone array of the user device, or the like. In some exemplary embodiments, the map view may present relative locations of activate and/or muted entities with respect to the user (the user device and/or its microphone array), with or without a respective identifier. For example, in case an identifier of an entity in the map view is unknown, the entity may be presented as an unidentified entity (e.g., with or without one or more default names used for unidentified objects) in the map view, in an estimated location thereof. In some exemplary embodiments, the map view may present suggestions of entities that are estimated to be within the vicinity of the user, e.g., based on acoustic signatures matching a captured audio signal, based on directions of arrival of speech or sounds, or the like.

In some exemplary embodiments, the map view may present suggestions of entities as part of a ‘bubble mode’, e.g., based on identifying directions of arrival that are dominant, that are scored above a threshold, or the like. For example, as part of the bubble mode, one or more angles may be binned and scored independently, such that bins that score above a threshold (e.g., dominant angles) may indicate a presence of an entity in the environment of the user. According to this example, in case a bin of angles scores above a threshold, and does not correspond to any activated entity, a new entity in the corresponding angles may be suggested to the user within a map view, e.g., as visual ‘bubble’ object, an icon, an overlay element, or the like. According to this example, the user may select the unknown entity in order to activate the entity.

In some exemplary embodiments, the map view may enable the user to activate or mute entities by mere selections of entities in the map view, to adjust a level of sound from a selected entity, or the like. For example, the map view may be generated based on directions of arrival of sounds from activated and/or non-activated entities in the environment. In some exemplary embodiments, a direction of arrival measurement may indicate a direction that is estimated to be most associated with an extracted voice of the activated entity, a dominant direction of speech, or the like, which may be defined with respect to a defined center or anchor. For example, a direction of arrival may be defined with respect to a location of one or more microphones, a relative orientation among microphones, a location of a mobile device, a location of hearables, or the like.

In some exemplary embodiments, users may be enabled to activate unknown entities, e.g., according to the method of FIG. 3B. For example, the user may wish to swiftly activate an unknown entity that does not necessarily have any profile, acoustic fingerprint, or the like. In some exemplary embodiments, in order to identify and activate an unknown or temporary entity, an intention of the user may be classified, to determine whether the user wishes to activate an unknown entity. For example, the intention may be determined automatically based on tracked user behavior, a new dominant direction of arrival, a contextual analysis of the user's conversation, or the like. As another example, the intention may be determined manually through manual input from the user, such as manual selections, gestures, commands, or the like.

In some exemplary embodiments, the user may be enabled to manually select an angle or relative location of the unknown entity with respect to the user or a device associated with the user. For example, the angle may be selected on the map view, from a circle representing 360 degrees around the user's device, or using any other user interface, and may indicate that the intention of the user is to activate an entity in the selected angle. For example, the angle may be selected on the map view that depicts identified known and/or unknown entities in relative positions around the user's device, from which the user may select a relative location or angle that corresponds to the unknown entity. For example, the map view may also depict a circle representing 360 degrees around the user's location, through which the user may select an angle of interest. According to this example, the manual angle selection may enable to determine that the user's intention is to hear a new entity. In some exemplary embodiments, the intention of the user may be determined automatically by tracking the user's motions and/or speech, e.g., the user's head movements, face direction, speech direction, or the like. In some exemplary embodiments, the intention of the user may be determined automatically based on a new dominant direction of arrival, a contextual analysis of the user's conversation, or the like. For example, in case the user's head movements are directed to a new dominant direction of arrival, the user's intention to activate the respective entity may be inferred.

In some exemplary embodiments, an angle of the unknown entity may be obtained from the user, or determined implicitly from the user's motions (e.g., an angle to which the head of the user moved), a direction of the entity's speech, a new dominant direction of arrival, or the like. In some exemplary embodiments, based on the provided angle, audio signals from the marked angle may be captured and processed to dynamically extract the entity's voice and include it in the audio output. For example, the audio may be captured from a DoA of the unknown entity, corresponding to the user-provided angle. As another example, an acoustic signature of the unknown entity may be generated or selected dynamically based on audio from the indicated angle, and the signature may be used to extract the sound of the entity from noisy audio signals. In some cases, a temporary profile of the unknown entity, including at least a dynamically generated signature, may be activated, or suggested to the user to be activated (via the map view). In some cases, the user may be prompted to save the profile permanently or discard the profile, to save the acoustic signature, to add an identifier of the unknown entity, or the like. In some exemplary embodiments, based on the acoustic signature of the unknown entity, the entity may be tracked even as it changes location, and its position in the map view may be adjusted accordingly.

In some exemplary embodiments, identifiers of entities in the environment of the user may be estimated, determined, or the like, such as based on the profiles of the entities, based on a personal address book of the user, based on a public address book available to the user, based on a social network platform, based on user indications, based on historic vocal communications of the user, based on messaging applications, based on a semantic analysis of a transcription of the conversation, based on calendar events, a combination thereof, based on a public database, or the like. For example, a name of a user's contact may be estimated to be the identifier of the contact.

In some exemplary embodiments, users may be enabled to adjust multiple settings, such as a proportion of the background noise that can be included in an output signal that is provided to the user's hearables, a volume or ratio of speech of each of the activated entities, whether or not mobile device sounds (e.g., ringtones) should be included, or the like, thereby providing to the user full control of the output audio. For example, a volume of an entity may be adjusted using a filtration mask, or any other signal processing technique.

One technical effect of utilizing the disclosed subject matter is to provide hearing devices with enhanced functionalities. For example, the disclosed subject matter enables users to gain full control over voice amplifications, by enabling the user to activate or mute desired people in the environment via a user interface of the user's mobile device. In some exemplary embodiments, by providing a mechanism for separating and processing sounds of activated entities, each sound may be processed and controlled independently, together, or the like, providing a full range of functionalities that can be performed on the isolated sounds. For example, increasing a sound of one entity and decreasing a sound of another entity cannot be performed without having independent isolated sounds of both entities.

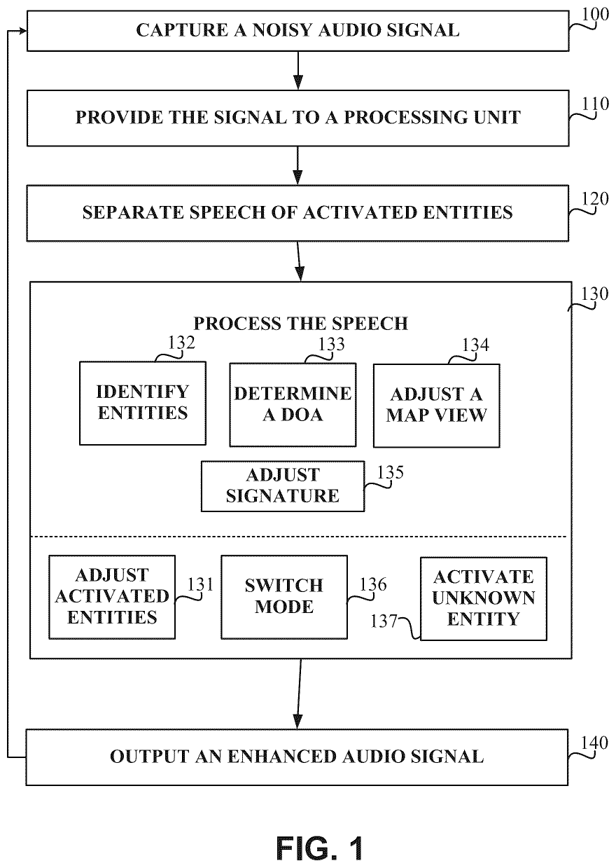

Another technical effect of utilizing the disclosed subject matter is enabling to separate voices of people in real time, and produce an output audio based thereon in real time (e.g., as part of the online processing described at least on Step 130 of FIG. 1), thus enabling to utilize the disclosed subject matter during a conversation. For example, the disclosed subject matter may enable a user to hear amplified voices of people with which the user is conversing, and to hear reduced volumes (or none at all) of the background noise, which may enhance an experience of the user by providing intelligible audio, reduce cognitive loads from the user, increase an ability of the user to participate in the conversation, while maintaining a desired level of involvement of the user with other entities in the user's environment, or the like.

Yet another technical effect of utilizing the disclosed subject matter involves the provision of both manual and automatic mechanisms for activating unknown entities, such as a waiter in a restaurant. These mechanisms offer users a flexible and user-friendly way to interact with unknown or new entities, ultimately enhancing the user experience across various scenarios.

Yet another technical effect of utilizing the disclosed subject matter is enabling to activate unknown entities for a temporary period, e.g., during a selection of a ‘press and hold’ control. For example, the mode of operation may be switched from ‘several’ to ‘everyone’ and then back to ‘several’, by a single selection of the ‘press and hold’ control during the relevant timeframe.

Yet another technical effect of utilizing the disclosed subject matter is enabling to present a map view of entities in the environment, through which the user may control the sounds of each entity that are provided to the hearables, activate new or temporary entities, or the like. For example, the map view may display real-time positions of entities in the user's surroundings and track them over time, even in case they are unknown entities.

Yet another technical effect of utilizing the disclosed subject matter is enabling an automatic or manual identification of people that are conversing with the user.

Yet another technical effect of utilizing the disclosed subject matter is enabling to prioritize some background noises, such as by retaining sounds of interest in a generated audio signal. The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

Referring now to FIG. 1 showing an exemplary flowchart diagram, in accordance with some exemplary embodiments of the disclosed subject matter. It is noted that although the steps of FIG. 1 are presented as sequential steps, they may not necessarily be performed in a sequential manner. For example, in some cases, Steps 120 and 130 may be performed in parallel, in one or more at least partially overlapping time periods, or the like. In some cases, the various steps may be processed at separate or different time windows, for example, separately when one processing step utilizes the output of another processing step.

On Step 100, a noisy audio signal may be captured from an environment of a user by one or more microphones, e.g., periodically. In some exemplary embodiments, capturing the noisy audio signal may comprise converting sound waves into analog or continuous electrical signals, converting analog electrical signals into digital data such as a discrete sampled signal that can be processed and stored by digital devices, or the like. In some exemplary embodiments, the noisy audio signal may comprise a mixed audio sequence, which may comprise one or more background noises, one or more human voices, one or more non-human voices, or the like. In some exemplary embodiments, the noisy audio signal may have a defined length, such as a defined number of milliseconds (ms), a defined number of seconds, or the like, and noisy audio signals may be captured periodically according to the defined length (e.g., chunks of 5 ms, 10 ms, 20 ms, or the like). In some exemplary embodiments, the noisy audio signal may be captured continuously, periodically, or the like. For example, the noisy audio signal may be captured sample by sample, e.g., without gaps.

In some exemplary embodiments, the noisy audio signal may comprise one or more audio channels that are captured by one or more respective microphones (also referred to as ‘mics’). In some exemplary embodiments, the microphones may be in a mobile device of the user such as a smartphone, in a computing device such as a Personal Computer (PC), within hearables, within a wearable device, within a dedicated device, within a dongle connected to a smartphone, or the like. In some embodiments, the computing device may comprise a tablet, a laptop, a user device, an on-board computing system of an automobile, an Internet server, or the like. For example, the microphones may comprise at least three microphones in the mobile device of the user.

On Step 110, the microphones may provide the one or more audio channels of the noisy audio signal, in a digital format, to a processing unit. For example, the processing unit may comprise a processing unit of the mobile device, a processing unit of the hearables, a processing unit of a computing device, a combination thereof, or the like. In some cases, at least a portion of the processing unit may be positioned in the same device as at least some of the microphones that captured the noisy audio signal. In some cases, at least a portion of the processing unit may be positioned in a different device from the microphones that captured the noisy audio signal. In some cases, the processing unit may process audio channels in their analog form, in their digital form, in a discrete form, a combination thereof, or the like.

In some exemplary embodiments, the microphones may provide the noisy audio signal to a processing unit using one or more communication mediums, channels, or the like. In some exemplary embodiments, in case the processing unit is housed in a same device as the microphones, the captured noisy audio signal may be provided to the processing unit via inter-device communications. For example, the captured noisy audio signal may be provided via a lightning connector protocol, a USB Type-C (USB-C) protocol, an MFI connector protocol, or any other protocol. In some exemplary embodiments, in case the processing unit is housed in a different device from the microphones, the captured noisy audio signal may be transferred to the processing unit via a beamforming transmission, or any other transmission that is configured for communication between separate devices.

In some exemplary embodiments, the processing unit may comprise any physical device having an electric circuit that performs a logic operation on input or inputs. In some cases, the processing unit may comprise a dedicated processing unit, such as an independent hardware device, an independent chip or unit, or the like. In some cases, the processing unit may comprise a component of mobile device, a user device, hearables, or the like. In some cases, the processing unit may comprise a portable device that may be mounted or attached to a wearable apparatus, hearables, a computing device, or the like.

On Step 120, the processing unit may apply sound separation, speech separation, or the like, on the noisy audio signal, to extract therefrom separate audio signals of activated entities in the environment. It is noted that when referring to speech separation, it may encompass sound separation. In some exemplary embodiments, the speech separation may be performed for one or more entities that are activated, opt-in, enabled, or the like (referred to herein as ‘activated entities’). In some exemplary embodiments, the activated entities may comprise human entities, non-human entities, or the like, and may or may not be identified.

In some cases, one or more profiles of entities may be generated, stored, or the like, e.g., in the mobile device, in a remote server, or the like. For example, contacts of the user may be stored in a profile, information associated with people with which the user had vocal communications using the mobile device may be stored in a profile, or the like. In some exemplary embodiments, profiles may or may not comprise an acoustic fingerprint of the respective entity. For example, user data may be analyzed to identify a vocal record of the entity (e.g., extracted from a call), and the vocal record may be processed to generate therefrom an acoustic fingerprint, which may be stored in the profile of the entity. In some exemplary embodiments, profiles may or may not comprise an identifier of the respective entity. For example, a user may have vocal records of an entity, without having any information about the entity, the entity's name, or the like. In some exemplary embodiments, the profiles may be used to enable users to activate or mute entities.

In some exemplary embodiments, entities in the environment may be activated in one or more manners. For example, at an initial stage (when activating an audio processing functionality of the disclosed subject matter), all profiles may be automatically opt-in without user intervention, e.g., unless muted by the user. As another example, profiles of entities may be opt-in if manually selected by the user, e.g., via a user interface enabled by the user's mobile device, via a tap or other user interaction with the hearing device, or the like. As another example, profiles of entities may be opt-in automatically in case they comply, or correspond, to user-selected settings. According to this example, the user may select one or more sounds of interest, contacts of interest, or the like, and the speech separation may be performed to obtain only sounds of the selected entities. As another example, profiles of entities may be opt-in in case an intention of the user to hear an unknown or new entity is identified. In some cases, the user may indicate profiles of one or more sounds or contacts that are not of interest to the user, and such profiles may not be activated, opt-in, or the like.

In some exemplary embodiments, in case of manual activation, a user may activate an entity via one or more user interfaces of the mobile device or any other device. For example, a software application (e.g., a mobile application, a web-based application, or the like) may present the user with profiles of potential non-human sounds of interest, contacts with which the user had vocal communication, contacts that are associated with an acoustic signature, people that are not contacts but are stored with an acoustic signature, contacts with which the user spoke in a recent period (a last timeframe such as a last week or month, or most recent conversations), or the like. According to this example, the user may select to activate entities by selecting people or sounds that she wishes to hear, such as by selecting respective GUI elements including touch screen or physical controls, via a voice command, a textual search bar, or the like. As another example, a map view may be generated to represent entities in the environment (e.g., using a direction of arrival analysis and speech separation techniques), and the user may be enabled to activate or mute represented entities via the map view. For example, the user may select an angle of an entity, and in response, the entity may be activated. As another example, entities may be activated automatically, without manual input, such as based on an identified intention of the user (e.g., a head movement in a new direction). In other cases, users may be enabled to activate entities, or their profiles, in any other way.

In some exemplary embodiments, voices of activated distinct entities that are identified in the noisy audio signal may be extracted, e.g., without necessarily processing or analyzing other voices or sounds. For example, instead of deploying the ‘everyone’ mode, a matching may be performed between activated entities and the noisy audio signal, without identifying or extracting other speech elements in the noisy audio signal. In such cases, the remaining sounds in the noisy audio signal may be treated as background noise, may be ignored, or the like. For example, a matching may be performed between an activated entity and the noisy audio signal by obtaining an acoustic fingerprint of the entity, and extracting from the noisy audio signal a signal that matches the acoustic fingerprint (if one is found).

In some cases, in case a user activates, for example via a map view, a human or non-human entity that has no associated acoustic fingerprint, existing acoustic fingerprints may be applied on the noisy audio signal, in an attempt to match the entity to an existing acoustic fingerprint. In other cases, a new acoustic fingerprint may be dynamically generated for the unknown entity, e.g., by directly recording an enrollment audio record of the entity and generating a new acoustic fingerprint based thereon. In other cases, any other technique may be used to activate an unknown entity, such as by identifying its direction of arrival, performing a general speech separation on the noisy audio signal, executing a description-based model with a description of the entity, or the like. For example, the general speech separation may utilize one or more separation techniques that do not require acoustic fingerprints, e.g., beamforming receiving array, audio source separation techniques, linear filters, Hidden Markov Models (HMMs), Dynamic Time Warping (DTW), Voice Activity Detection (VAD), Blind Signal Separation (BSS), Spectral Subtraction, Wiener Filtering, deep learning models such as Convolutional Neural Networks (CNNs) or Recurrent Neural Networks (RNNs), clustering algorithms, transformers, conformers, or the like. For example, CNNs may be trained to map between audio mixtures and individual sources. In such cases, an acoustic fingerprint may be generated for the activated entity based on an identified voice in the noisy audio signal. For example, the general speech separation may output one or more audio signals associated with unknown speakers, and a user may select which of the unknown speakers is associated with the entity. As another example, the user may select to activate an entity via a map view, and the indicated location of the entity may be used to select which of the audio signals associated with unknown speakers is associated with the entity, e.g., using beamforming techniques. As another example, a number of unknown voices may be recognized in the noisy audio signal, and a temporary profile or cluster (of parts of the audio that are spoken by the same entity) may be dynamically created for each voice. The temporary profile may then be presented to the user, e.g., via the map view, so that the user may decide whether to activate the unknown entity, identify the unknown entity, associate the unknown entity with a contact or profile, or the like. In some cases, the temporary profile may be presented without an identifier of the entity, but may potentially indicate a location of the entity relative to a defined location (such as a location of the user), e.g., based on a direction of arrival of each voice, a user selection of a respective angle, or the like.

In some exemplary embodiments, one or more channels of the noisy audio signal (e.g., captured by respective microphones) may be provided to a speech separation model. In some exemplary embodiments, one or more acoustic signatures of activated entities may be provided to the speech separation model. In some exemplary embodiments, the speech separation model may transform the channels to a frequency domain (e.g., using a Short-Time Fourier Transform (STFT) operation, a neural network, or any other operation), and apply a separation operation thereon, such as in order to extract voices associated with the obtained acoustic signatures from the noisy audio signal. In some cases, the speech separation model may tokenize the channels to discrete or continuous tokens using one or more engineered or learned audio compression techniques, and apply a separation operation on the tokens. In some exemplary embodiments, the speech separation model may be configured to separate voices of at least a portion of the activated entities. For example, the speech separation model may extract from the noisy audio signal voices of all activated entities, of entities that are estimated in higher chances to be present in the environment (e.g., based on the noisy audio signal, past conversations of the user, calendar events of the user, or the like), of entities that are not muted, or the like. In some exemplary embodiments, the speech separation model may use a generative model to generate and output audio signals of the separated voices or spectrograms thereof. In some exemplary embodiments, the speech separation model may utilize a discriminative mask model that is multiplied by the input to filter out undesired audio.

In some cases, speech separation models may be trained to extract a voice of an entity from a noisy signal using a vocal record of the entity. For example, the vocal record may be obtained by recording the entity with a computing device of the user, from a storage of a computing device (e.g., stored voice messages), or the like. In some exemplary embodiments, the speech separation model may utilize one or more designated speech separation models. For example, the speech separation model may comprise a designated speech separation model for each activated entity (e.g., or at least a portion of the activated entities). According to this example, each designated speech separation model may be configured to extract a voice of the associated entity, and to output a separated voice of the entity that is extracted from the noisy audio signal (e.g., the ‘several’ mode). In some exemplary embodiments, a designated speech separation model may recognize a voice of the entity and isolate the voice from any remaining voices, sounds, and noise (e.g., the background noise) in the environment of the user.

As another example, a single speech separation model may be configured to extract sounds of two or more associated entities. In such cases, a single speech separation model may be utilized for a plurality of activated entities. For example, the single speech separation model may be configured to extract voices of the associated entities, such as by applying a plurality of acoustic fingerprints of the respective plurality of entities on the noisy audio signal. According to this example, the single speech separation model may output a single channel or spectrogram comprising the combined speech by all sounds in the noisy audio signal that are estimated to match the acoustic fingerprints. As another example, each designated speech separation model may be configured to filter out a respective speaker. For example, a speech separation model may provide all sounds except for the voice of the user, or a selected sound of any other entity. In some cases, a single speech separation model may be configured to remove reverberation and echoing from the output signal.

It is noted that in some cases, the voice of the user herself may not be separated on this step, e.g., in order to ensure that the user's voice is not echoed, which enhances a user experience of the disclosed subject matter. In some cases, the user's own voice may be separated using an acoustic fingerprint of the user, their estimated direction with respect to the microphone array of the capturing device, or the like, but may not be opted in and thus not transmitted to the user's hearables. In other models, the user's own voice may be actively removed from the output audio. In some cases, such as in the case of a non-human sound of interest (SOI), speech separation models that do not require acoustic fingerprints may or may not be used, e.g., using a sound retrieval model that is trained to retrieve audio based on textual descriptions of the audio, such as the textual description: “Ambulance”.

In some exemplary embodiments, one or more verification steps may be performed, e.g., in order to verify that the voice extracted from the speech separation model is indeed the voice of the respective entity. For example, a verification may be useful in case a voice of an activated entity is not included in the noisy audio signal, in case the speech separation model matched the obtained fingerprint with a wrong voice (e.g., a similar voice) in the noisy audio signal, or the like. In some exemplary embodiments, extracted audio signals, that are provided by the speech separation models, may be verified, such as by using a verification module. In some exemplary embodiments, at least one verification module may be used for each respective speech separation model that is executed. In some exemplary embodiments, the verification module may be configured to obtain one or more channels of the noisy audio signal, an acoustic fingerprint of the respective entity, the extracted audio signal (e.g., a single channel), or the like, and to verify that the fingerprint corresponds to the extracted audio signal. In some cases, the extracted audio signal may not be received or utilized by the verification module, and instead, the verification module may obtain the noisy audio signal, along with an acoustic fingerprint of the respective entity and/or a direction of interest of the respective entity. In such cases, the verification module may indicate, for each chunk of noisy audio signal that is captured in the environment, whether or not the entity represented by the acoustic fingerprint is vocally present in the noisy audio signal, whether the noisy audio signal arrives from the indicated direction of interest, or the like.

In case the verification stage is not complied with (if the entity is not vocally present in the noisy audio signal, or is not associated with the indicated direction of interest), this may indicate that the speech separation model extracted a wrong sound. In some exemplary embodiments, the verification module may output an indication of success or failure. For example, the verification module may output a value of one in case of successful verification, and a value of zero otherwise. As another example, the verification module may generate a continuous score, e.g., a confidence score, indicating a probability that the entity is vocally present in the noisy audio signal. According to this example, the generated values may be separated by the verification module to a value of zero, when a value is lesser than a threshold, and to a value of one, when the value is greater than (or equal to) the threshold. In other cases, indications of whether or not the verification was successful may be provided in any other way, e.g., using different values. In some exemplary embodiments, the output of the verification module may be used as a filtration mask, thus enabling to filter out extracted voice from the speech separation model that are not verified. For example, the output value of the verification module may be multiplied with the extracted voice from the speech separation model, causing the extracted voice to be filtered out in case the verification is unsuccessful.

In some exemplary embodiments, in case more than one speech separation model and/or respective verification module are executed, the models may be executed concurrently, in at least partially overlapping timeframes, in separate timeframes, or the like, such as in order to obtain one or more verified separated audio signals that are extracted from the noisy audio signal. In other cases, such as in case the extracted sounds are not verified with a sufficiently high confidence score (e.g., above a threshold), or in case that none of the separated audio signals are successfully verified, the extracted sounds may be disregarded, and the enhanced audio signal may be generated in a different manner, e.g., by removing background noise, using beamforming receivers, or the like. For example, a neural network may be trained to extract human speech from background noise. In some exemplary embodiments, in case at least one separated audio signal is successfully verified, the verified separated audio signals may be processed and combined in one or more manners, e.g., according to Step 130.

On Step 130, separated speech of activated entities may be processed, e.g., in order to enable the user to control an output based on the separate audio signals. In some exemplary embodiments, the processing unit may perform one or more processing operations on the separate audio signals, such as combining the separate audio signals, amplifying one or more separate audio signals, attenuating one or more separate audio signals, limiting an overall volume of a combined audio signal, adjusting the audiogram of the combined audio signal in accordance with the user's hearing profile, applying filtration masks on the separate audio signals to attenuate or amplify one or more signals, enabling the user to adjust a volume of the background noise, enabling the user to adjust one or more parameters, applying audio compression or other DSP operations, or the like.

In some exemplary embodiments, amplification may be accomplished digitally, such as by changing one or more parameters of the microphones, using a beamforming microphone array, or the like. In some exemplary embodiments, additional processing of the separate audio signals may comprise changing a pitch or tone of the separate audio signals (e.g., in case the user is less sensitive to tones in a certain range), mapping the separate audio signals to higher or lower frequencies, changing a rate of speech of the separate audio signals (e.g., using phase vocoder or other learnable time stretching methods), introducing pauses or increased durations of pauses between words and/or sentences of the separate audio signals, or the like.

In some exemplary embodiments, processing of the separate audio signals may be performed online or offline. In some exemplary embodiments, online processing may refer to processing of the noisy audio signal with a zero or minimal accumulated delay, for example below a threshold, such that the user may be enabled to participate in a conversation using the processed outputs that are based on the noisy audio signal. In some exemplary embodiments, offline processing may refer to non-real-time processing, near real time processing, or the like, which may have an increased accumulated delay compared to the online processing. For example, online processing may have an overall delay threshold of five milliseconds (ms), ten ms, twenty ms, or the like, while offline processing may have an overall delay threshold of one minute, two minutes, or the like. In some cases, certain operations such as speaker diarization (during which unknown speakers are automatically segmented and identified in audio) or identifying the presence of unknown entities in audio signals, may be performed more efficiently in retrospect (not necessarily due to computational overload, but due to more information being available), and may be performed as part of the offline processing. For example, such operations may utilize a longer time window than other operations, enabling the operations to be performed with higher confidence scores of entity identifications.

In some exemplary embodiments, Step 131 may be performed as part of the online processing, while Steps 132, 133, 134, and 135 may be performed as part of the offline processing. In other cases, Step 131 may be performed as part of the offline processing.

On Step 131, selections of activated entities may be adjusted. In some exemplary embodiments, the user may be enabled to dynamically change the selection of activated entities in real time, e.g., via the user interface of the mobile device. For example, the user may select to activate an entity in the map view in case the entity joins a conversation of the user, and then deselect the entity, causing the entity to be muted, such as in case the entity leaves the conversation, bothers the user, or the like. In some cases, selections of activated entities may be adjusted automatically, such as upon identifying that an activated entity left the environment of the user (e.g., using the DoA calculation of Step 133). As an example, a person may be opted in automatically, in response to identifying that an activated entity referred to the person by name.

In some exemplary embodiments, the processing unit may obtain user selections, and provide them to the speech separation model, e.g., as part of the online processing. For example, in response to an indication that Alice is not activated any more, the speech separation model may terminate a designated speech separation model of Alice, a designated verification module of Alice, or the like, e.g., in a next iteration of the flowchart of FIG. 1.

On Step 136, modes of operation may be switched. In some exemplary embodiments, the user may be enabled to dynamically change the mode between ‘everyone’ mode and ‘several’ mode, such as by clicking on a ‘press and hold’ control. For example, the speech separation model may be deactivated in case of an ‘everyone’ mode, and only background noise may be removed using one or more filters such as spectral subtraction, Wiener filtering, Bayesian estimation, or the like. In some exemplary embodiments, modes of operation may be switched based on manual input from users, or an automatic detection of a user's intention to switch modes (potentially delaying the switch to a next iteration). In other cases, Step 136 may be applied offline.

On Step 137, unknown entities may be activated, based on one or more manual input from users, an automatic detection of a user's intention to switch modes, or the like. For example, the user's behavior may be tracked by one or more sensors, such as image sensor, audio sensor, IMU, electroencephalogram (EEG) sensor, or the like, and based thereon, an intention of the user may be classified into a first class for activating unknown entities or a second class for not activating unknown entities. For example, an EEG sensor that measures or tracks brain activity may be added to hearable devices of the users, and used to classify the user's intention. In some exemplary embodiments, the intention may be classified based on a head movement of the user, an angle toward which the user faces, a direction of speech of the user, a direction of arrival of sounds from an unknown entity, or the like. In some exemplary embodiments, the intention maybe determined based on manual input such as a manually provided angle or direction of the unknown entity with respect to the user, a manual gesture, a manual selection of an object in the map view (e.g., provided based on a detection of a new dominant direction of arrival), or the like. For example, the user may perform a manual interaction with the hearing device, indicating that the user has an intention to hear a consecutive sound, a sound of an unknown entity, or the like. In some exemplary embodiments, based on a manually provided angle, or on an angle of movement of the user, a direction of arrival of voice from the unknown entity may be determined and used to extract the voice and serve it to the user. In some cases, based on the determined intention to activate a temporary entity, the temporary entity may be activated and Step 135 may be applied thereto offline. In other cases, the intention may be classified as part of the offline processing.

On Step 132, as part of the offline processing, one or more activated entities may be identified. In some exemplary embodiments, in case an activated entity is not identified, or is wrongly identified, the identifier of the entity may be estimated. In some cases, the user may be prompted to confirm or reject the estimated identity of one or more entities, e.g., in case a confidence score of an estimation is below a threshold. In some cases, the user may directly edit an identifier (a name of the entity) of an entity, e.g., in case the estimated identity is inaccurate. In some exemplary embodiments, in response to a user's activation of a contact, the processing unit may estimate an identifier of the contact, such as his name. For example, in case the contact is stored in association with a name, a photo, an avatar, a title, or the like, the processing unit may estimate that the name of the contact is the identifier of the contact. In some exemplary embodiments, in case that the contact is not stored in association with a name, or in case the entity is not a contact of the user's mobile device, other methods may be used to estimate an identifier of the entity.

As an example, an identifier of an entity may be estimated by analyzing a transcript associated with one or more subsequent noisy audio signals with a semantic analyzer. The semantic analyzer may be configured to identify names used in a transcript of a conversation of the user, associate the names with directions of arrival of different voices, and estimate matches between names and profiles of the respective voices. According to this example, the semantic analyzer may be applied to a transcription of the conversation, which may be extracted using Automatic Speech Recognition (ASR), computer speech recognition, speech-to-text models, or the like. In some cases, the semantic analyzer may comprise a Large Language Model (LLM), a Small Language Model (SLM), or any other Natural Language Processing (NLP)-based model.

As another example, an identifier of an entity may be estimated based on historic data. In some cases, a conversation of the user may be correlated to historic conversations of the user, to extract one or more contexts therefrom. An historic analysis may reveal clusters of speakers that tend to have conversations together. For example, the user may usually meet with Alice together with Bob. According to this example, in case Bob is identified as speaking in the noisy audio signal, a temporary profile of an unknown voice may be estimated to belong to Alice. As another example, historic analysis may reveal that the user usually speaks during conferences with Alice, and during holidays with Bob. Such information may be correlated with current dates (e.g., obtained from remote servers, a clock of the mobile device, or the like), with holiday dates, with transcriptions of the conversation, or the like, in order to estimate whether the user is participating in a conference or celebrating a holiday, based on which the identifier may be selected to be Alice or Bob.

As another example, an identifier of an entity may be estimated based on recent activities of the user. For example, an activity log of the user may indicate that the last people with which the user spoke were Alice, Bob, and Charlie, and the processing unit may estimate that the current entities in the environment of the user are correlated with the last people with which the user spoke.

As another example, an identifier of an entity may be estimated based on a calendar event of the user. For example, a calendar event of the user may indicate that the user is currently participating in a meeting with Alice and Bob, which may increase the probability that an identifier of an unrecognized entity is either Alice or Bob.

In some cases, a probability that an entity is associated with one or more identifiers may be calculated based on a combination of one or more weighted or unweighted metrics, and an identifier with a highest probability may be utilized as the identifier of the entity, suggested as the identifier of the entity, or the like. For example, the processing unit may determine that the last people with which the user spoke were Alice, Bob, and Charlie, and that usually the user speaks separately with Alice and Bob, and separately with Charlie. In such cases, identifying that one of the activated entities is Bob, may be used to infer that the unidentified entity is Alice. As another example, a list of one or more identifiers with a highest matching score may be presented to the user in association with an unrecognized entity, and the user may select the correct identifier from the list.

In some exemplary embodiments, an identifier of an activated entity may not always be estimated, suggested, or the like. For example, a temporary profile with a dynamically generated acoustic fingerprint may be generated for an unrecognized person, e.g., a waiter in a restaurant, such as in response to Step 137, and in case the temporary profile is not identified in the noisy audio signals for more than a defined time period, an estimation of a respective identifier may not be performed.

In some cases, the user may be provided with suggestions to mute or activate one or more entities. For example, in case a semantic analyzer estimates that an activated entity is participating in a different conversation from the user, the processing unit may suggest to the user to mute the activated entity. As another example, in case a semantic analyzer estimates that a non-activated entity joined a conversation of the user, the processing unit may suggest to the user to activate the entity.

On Step 133, in order to provide to the verification module of Step 120 a direction of interest, one or more beamforming receiving arrays or learnable methods (such as neural networks that are trained for DoA estimation) may be utilized by the processing unit to estimate a Direction of Arrival (DoA) of the entity's voice. In some exemplary embodiments, the processing unit may determine one or more dominant directions in the noisy signal. In some exemplary embodiments, the DoA model may obtain, as input, one or more channels of the noisy audio signal as captured by respective beamforming receivers, a separated audio signal that was separated and/or verified by one or more speech separation models and verification module, a signature of the entity, or the like.

In some exemplary embodiments, the DoA model may utilize an angle model to estimate one or more dominant directions of the channels of the noisy audio signal, such as by applying a beamformer on each angle, on each set of angles, on each bin of one or more angles, or the like. For example, the angle model may compare the relative timing, amplitudes, or the like, of captured voices to determine a directionality. In some cases, each beamformer that is applied independently to a bin of one or more angles may constitute a separate detector for the respective direction. In some exemplary embodiments, a score for each bin may be assigned based on the beamformers. In some exemplary embodiments, a score may be assigned to a single angle, denoted by 0, or to a range of angles. In some cases, a score may not be calculated for one or more angles or angle ranges, e.g., in case a probability that they are relevant is determined to be low. For example, 360 scores may be determined, one for every degree. As another example, 90 scores may be determined, one for every set (or bin) of four adjacent degrees. In other cases, the resolution and/or number of angles within each bin may be adjusted or set during model training to include any number of degrees.

In some exemplary embodiments, one or more dominant angles in the noisy signal may be determined based on the scores, e.g., through a multi-class setup or a multi-task setup. In some exemplary embodiments, in a multi-task approach, each bin of one or more angles may be evaluated independently, allowing to identify more than one dominant direction simultaneously. For example, this may enable to detect multiple active speakers or sound emitter in the environment of the user, and to accurately model conversations with multiple speakers (e.g., by presenting respective entities in the map view). In some exemplary embodiments, the dominant directions may be identified in case of respective bin scores exceed a threshold, in case an average score of one or more adjacent bins exceeds a threshold, or the like. In some cases, one or more identified dominant directions may have one or more overlapping angles. For example, a first dominant direction may be identified as angles 3-15, and a second dominant direction may be identified as angles 13-24.

In some exemplary embodiments, in a multi-class setup, only one angle may be selected as the dominant direction. For example, a single dominant angle may be determined based on the assigned scores to angles or bins, e.g., by selecting a highest score, a highest average score for a set of adjacent angles, or the like. In some cases, the multi-task approach may be advantageous for a scenario with more than one entity that the user wishes to hear.

In some exemplary embodiments, the DoA model may obtain the one or more dominant angles from the angle model, and verify that the dominant angle is associated with the respective entity, such as by comparing the separated audio signal to the acoustic signature of the entity, and ensuring that they match. In some exemplary embodiments, the verification performed by the DoA model may overcome one or more drawbacks. For example, in case voices of a plurality of people is obtained from a same direction (e.g., from overlapping angles), which reduces the ability to separate the voices, verifying that the voice complies with the respective acoustic fingerprint may ensure that the voice separation is performed properly. In some exemplary embodiments, the verification operation may be performed by the DoA model in case at least one dominant angle is found. In some cases, in addition to speaker verification, the DoA model may perform one or more additional processes such as applying one or more smoothing operations to refine the direction estimate of the angle model.

In some exemplary embodiments, in case the DoA model verifies one or more dominant angles as being associated with respective entities, the respective bins may be provided to the verification module of Step 120, such as in order to determine a correct filtration mask for the separated audio signal. In some exemplary embodiments, in case a dominant angle is not verified, the dominant direction may be disregarded, e.g., providing a NULL value to the verification module of the entity. In some cases, such as in case that no activated entity is speaking in the noisy audio signal, no dominant angle from the angle model may be provided to be verified by the DoA model.

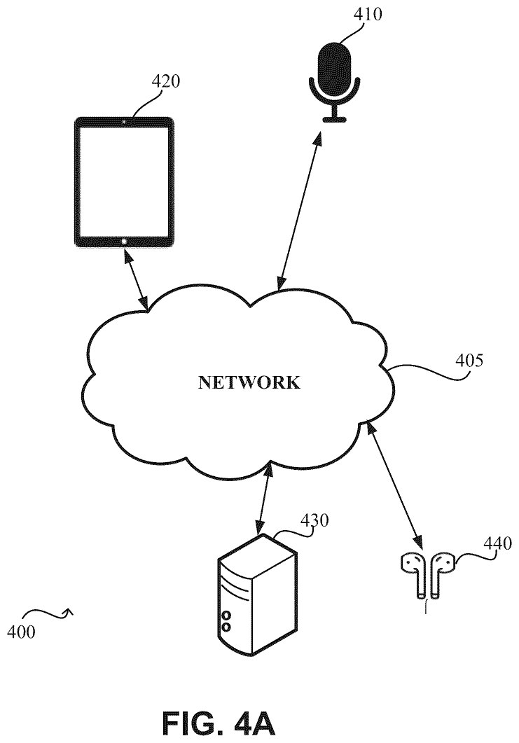

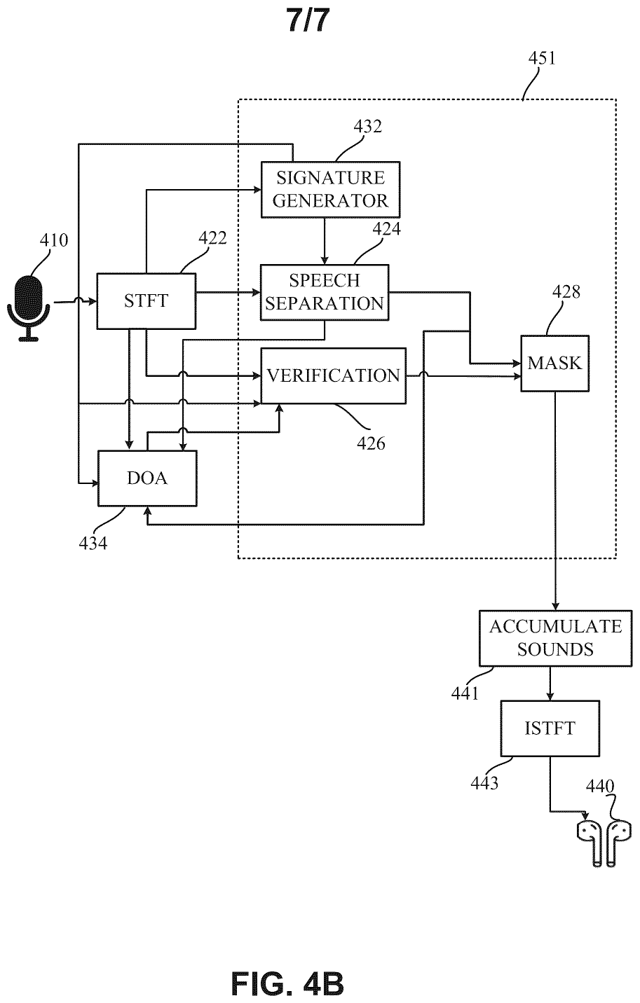

In some exemplary embodiments, DoAs of entity sounds may be adjusted or calibrated periodically, such as every time that a different entity is separated from the noisy audio signal, every defined time period, by user request, or the like. In some cases, DoAs may be calculated for non-activated entities, e.g., at a lower rate. For example, voices of entities that were muted by the user, that were not activated by the user, or the like, may be identified in a noisy audio signal, and their DoA may be monitored, such as in order to present them in the map view, in order to increase a speed of separating their voice in case the user activates these entities, or the like. For example, a latency of verifying a separated voice of an entity that is activated may be reduced, in case a DoA of the entity is known, e.g., as described in FIG. 4B. In some exemplary embodiments, DoAs of activated entities may be calculated in a higher frequency than DoAs of non-activated entities. For example, if DoAs of activated entities are calculated every minute, DoAs of non-activated entities may be calculated every five minutes. In some cases, DoAs of an entity may be calculated based on a number of times that the entity's voice appears in the noisy audio signals. For example, every 5, 10, 20 times, or the like, that the entity's voice appears in the noisy audio signals, a new DoA may be calculated for the entity, e.g., unless a defined time duration has elapsed since the last calculation. In some cases, different DoA estimation resolutions, such as angle range bins, may be assigned to different entities. In some cases, a DOA angle assigned to an entity may be provided to the speech separation model of the same entity.

On Step 134, a map view that is presented on a user interface of the mobile device may be adjusted, e.g., based on changes in a Direction of Arrival (DoA) of sounds from one or more entities. In some exemplary embodiments, the map view may display locations of entities in the environment of the user, relative to a location of the user, a location of the mobile device, a location of one or more microphones of a capturing device, or the like. In some cases, the ‘location of the user’ may refer to any location that is associated to the location of the user, such as the location of the mobile device of the user, the location of a wearable device of the user, the location of the microphones, or the like. In some exemplary embodiments, the map view may be created and adjusted based on captured audio signals, acoustic fingerprints, periodically determined DoAs associated with one or more entities, the bubble mode, or the like.

It is noted that the verification module and the speech separation model described on Step 120 may be utilized as part of the online processing, e.g., during every iteration of the flowchart of FIG. 1, while the DoA model may be utilized as part of the offline processing. In other cases, the DoA model may be utilized as part of the online processing.

On Step 135, acoustic signatures of one or more entities may be enhanced, generated, or the like, e.g., as part of the offline processing. For example, noisy audio signals may be obtained and used to enhance an associated acoustic signature, generate a new acoustic signature, or the like. For example, an existing acoustic signature may be adjusted to take into account the voice of the entity as perceived in the noisy or enhanced audio signal. As another example, an acoustic signature may be dynamically generated for an unknown or temporary entity, such as based on audio streams in which the entity's voice is present. For example, the entity's voice may be determined to be present in a speech in case the user indicates an angle between the user and the entity (e.g., via the map view), and the speech may be determined to arrive from the angle.

On Step 140, an enhanced audio signal may be outputted, e.g., to hearables of the user, a hearing aid device, a feedback-outputting unit, to a user device with speakers, or the like. In some exemplary embodiments, the enhanced audio signal may be processed, combined, and provided to hearables of the user, e.g., where the output signal may be reconstructed. In some exemplary embodiments, the processing unit may be configured to communicate the enhanced audio signal via one or more communication means, such as Bluetooth™. In some exemplary embodiments, the enhanced audio may undergo audio compression, audiogram adjustment according to the user, constant amplification or attenuation, gain adjustment, or the like.

In some exemplary embodiments, the enhanced audio signal may comprise a combination of the separate audio signals, one or more non-activated entities, background noises of one or more types, or the like. In some exemplary embodiments, the user may be enabled to adjust the audio settings in a way that allows her to hear a specific proportion of the background noise and the separate audio signals. For example, the user may select to hear a ratio of one-third of the background noise and two-thirds of the separate audio signals.

In some exemplary embodiments, the hearables may comprise a speaker associated with an earpiece, which may be configured to output, produce, synthesize, or the like, the enhanced audio signal. In some exemplary embodiments, the generated enhanced audio signal may enable the user to hear activated speakers, without necessarily hearing any non-activated speakers, background noise, or the like. In some exemplary embodiments, iterations of the flowchart of FIG. 1 may be performed continuously, such as to enable a conversation of the user to flow naturally.

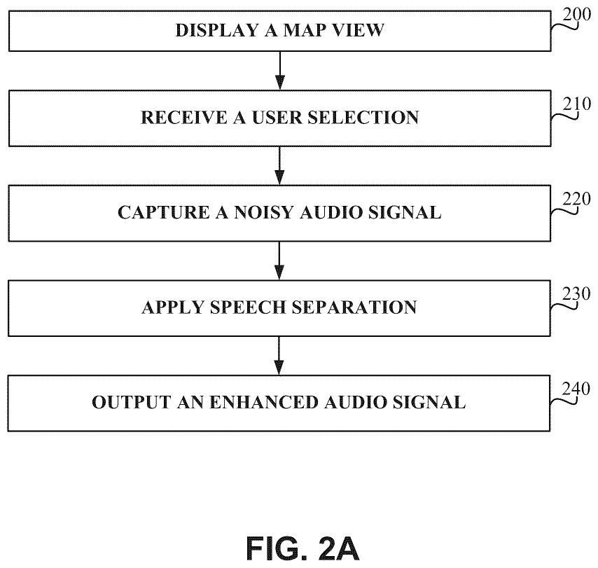

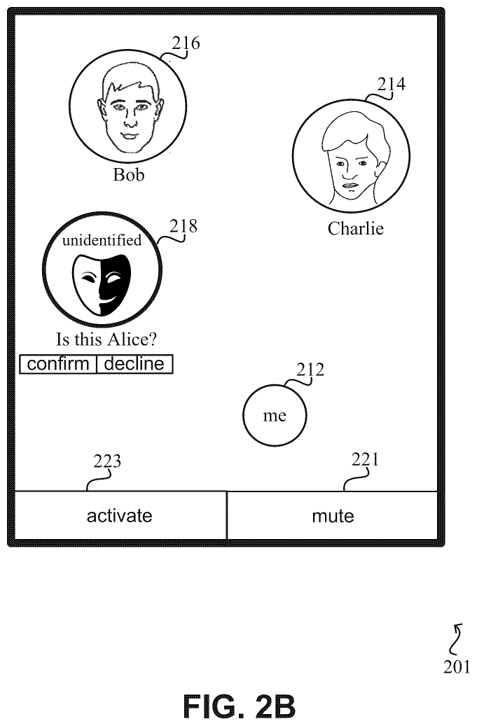

Referring now to FIG. 2A showing an exemplary flowchart diagram of a method, in accordance with some exemplary embodiments of the disclosed subject matter.

In some exemplary embodiments, the method may be performed in a noisy environment of a user. In some cases, the noisy environment may comprise a plurality of people participating in at least one conversation. In some exemplary embodiments, the user may have a mobile device used at least for obtaining user input, and at least one hearable device such as hearables used for providing audio output to the user, to Bluetooth™ receivers of the user, or the like. In some cases, the audio output may be made available to the user without being provided immediately to the user, such as by storing records of the audio output in a computing device that is accessible to the user, in a server that can be accessed by a user device, or the like.

On Step 200, a map view may be generated and displayed to the user, e.g., via the mobile device. In some exemplary embodiments, the map view may depict locations of one or more entities in the environment of the user, relative to a location of the user (e.g., a location of the mobile device), a location of the microphones, a location of the hearables, or the like. In some cases, the map view may depict indications of activated sounds of interest, such as via a side panel, a bottom panel, a cloud image, or the like.

In some exemplary embodiments, the map view may be generated, manually or automatically, based on a direction of arrival analysis of voices in one or more audio signals captured from the environment. In some exemplary embodiments, the direction of arrival analysis may be performed using a beamforming receiver array, a learnable probabilistic model such as a neural beamformer, or the like. In some exemplary embodiments, during direction of arrival analysis, a direction of arrival may be measured in all directions, such as in order to find a most probable direction from which each voice originated. In some exemplary embodiments, the direction of arrival analysis may be applied for one or more identified voices in the captured audio signal, e.g., separately, together, or the like.

In some exemplary embodiments, the map view may be generated to comprise identifiers of one or more of the plurality of people, of other entities, or the like. In some exemplary embodiments, an identifier of an entity may be determined based on user indications. For example, an identifier of an unrecognized entity (e.g., the target person) in the map view may be received from the user, and the map view may be updated to display the identifier adjacently to a map object representing the unrecognized entity. The unrecognized entity may or may not comprise a human entity.

In some exemplary embodiments, an identifier of an entity may be determined based on a profile of an unidentified entity, an acoustic signature of an unidentified entity, contact information, or the like. For example, a voice of an unidentified entity from the plurality of people may be obtained, and matched with a stored acoustic fingerprint of a person. According to this example, an identifier of the unidentified entity may be extracted based on the matching, e.g., based on a title of the acoustic fingerprint, profile, contact information of the respective contact, or the like. As another example, in case that an acoustic fingerprint of an unidentified entity does not match any stored fingerprint, an identifier for the fingerprint may be determined, e.g., based on a user indication, an estimated identifier as estimated by a sematic analyzer, or the like. In some cases, identifiers of entities may be retained in a database with pairs of identifiers and matching pre-generated acoustic fingerprints, enabling a swift extraction of the identifier for every matched fingerprint.

In some exemplary embodiments, acoustic fingerprints may be obtained from past vocal communications of the user, and may be stored independently, within a profile, within a contact record, or the like. In some exemplary embodiments, the past vocal communications with the user may comprise voice messages transmitted via an Instant Messaging (IM) service, a Voice over IP (VOIP) service, a social network platform, or the like. In some exemplary embodiments, the past vocal communications with the user may include voice messages are obtained from a WhatsApp™ application, a WeChat™ application, past video communications, a media-sharing platform, a social network platform, or the like.

In some exemplary embodiments, an identifier of an entity may be determined based on contact information of the entity, which may be obtained from a personal address book of the user, a public address book available to the user, a contact record that is stored in the mobile device externally to the personal address book, a social network platform, or the like.

In some exemplary embodiments, an identifier of an entity may be determined based on a calendar event of the user. For example, the calendar event may indicate an identity of a person, and an unrecognized entity may be estimated to correspond to the person, e.g., in case an acoustic signature of the person is not available.

In some exemplary embodiments, an identifier of an entity may be determined in any other way, and used to adjust the map view. In other cases, identifiers of entities may be calculated for other purposes, such as for providing the user with a list of entities to activate, without necessarily using a map view.

On Step 210, a user selection of a target person from the map view may be received from the user, via the mobile device. For example, the user may press on the target person, use a vocal or textual command to select the target person, or the like. In some exemplary embodiments, the selection may comprise an activation selection, e.g., causing the target person to be activated in case the user wishes to hear the target person. In other cases, the selection may comprise a muting selection, e.g., causing the target person to be deactivated, muted, or the like. In some cases, the selection may be a toggle selection, e.g., activating the target person if inactive, and vice versa.

On Step 220, a noisy audio signal may be captured from the environment. In some exemplary embodiments, the noisy audio signal may comprise one or more human sounds, one or more non-human sounds, one or more background sounds, or the like. In some exemplary embodiments, the noisy audio signal may be captured by a single microphone, by multiple microphones (e.g., a beamforming microphone array), or the like. For example, a single channel may be obtained in case of a single microphone, and multiple channels may be obtained in case of multiple microphones, respectively.

On Step 230, the noisy audio signal may be processed at least by applying one or more speech separation models, to isolate one or more sounds. For example, in case the user selection was an activation selection, a speech separation model of the target person may be applied on the noisy audio signal, and in case the voice of the target person is identified in the noisy audio signal, the voice may be isolated, extracted, or the like. In some cases, speech separation models of any other activated entities may be applied on the noisy audio signal.

In some exemplary embodiments, the isolated speech signals that are extracted by the speech separation models from the noisy audio signal may be processed, combined or the like, to generate an enhanced audio signal. In some exemplary embodiments, in case the noisy audio signal includes the voice of the target person, the enhanced audio signal may be generated to include at least the voice of the target person, e.g., since the user activated the target person. In other cases, such as in case the selection included a muting selection, speech separation of the target person may not be performed, resulting with the enhanced audio signal excluding a voice of the target person.

On Step 240, the enhanced audio signal may be provided to the user's hearables, and outputted to the user via the hearables. For example, the enhanced audio signal may be transmitted to the hearables from the user's mobile device, from a different processing unit, or the like, enabling the hearables to obtain the audio signal, convert the signal to the time domain, and emit the sound (e.g., using speakers) to the user.

In some exemplary embodiments, the enhanced audio signal may enable the user to hear the desired entities with an enhanced intelligibility, clarity, audibility, or the like, at least since the enhanced audio signal may amplify voices of activated entities, may not provide voices of non-activated entities, or the like. In some exemplary embodiments, the enhanced audio signal may enable the user to hear background sound in a reduced capacity, to remove background sounds, or the like, e.g., by not including the background sounds in the enhanced audio signal. For example, a background sound may comprise a voice of non-activated people such as the second person, a sound of a non-activated non-human entities, or the like. In case a certain proportion of the background sound is set (e.g., by the user) to be provided in the enhanced audio signal, the enhanced audio signal may be generated to include a portion of the background sound.

In some exemplary embodiments, the map view may be automatically adjusted, e.g., by measuring DoAs every defined timeframe and adjusting the map view accordingly (e.g., using acoustic signatures to correlate directions to entities), in response to identifying one or more events (e.g., an entity spoke after being quiet for more than a defined timeframe), or the like. In some exemplary embodiments, the map view, as well as the directions of arrival measurements, may be updated as part of the offline processing. For example, during a direction of arrival analysis on Step 133 of FIG. 1 (e.g., based on one or more noisy audio signals), an original direction of arrival of a voice of a person in the environment may be determined. In some exemplary embodiments, the map view may be generated based on the original direction of arrival, to depict a relative location of the person as calculated by the direction of arrival analysis. In some cases, after determining the original direction of arrival, one or more second noisy audio signals may be captured in the environment, and a second direction of arrival of the voice of the person may be inferred therefrom. For example, the second direction of arrival may be different from the original direction of arrival of the voice of the person. In such cases, the map view may be updated to reflect the modified relative location of the person based on the second direction of arrival, whereby presenting an updated map view with an up-to-date relative location of the person.

In some exemplary embodiments, directions of arrival may be calculated differently for activated and non-activated entities. For example, a direction of arrival of a non-activated entity may be measured every first time period, while a direction of arrival of an activated entity may be measured every second time period, e.g., the first time period is greater than the second time period. For example, the first time interval may be five minutes and the second time interval may be ten minutes. In other cases, any other configuration may be used, e.g., directions of arrival may be calculated at same intervals regardless of whether the entities are activated or not. In some exemplary embodiments, setting time intervals for measuring directions of arrival may not necessarily provide inaccurate map views, even if the time intervals are large (e.g., greater than a threshold), e.g., since entities may typically not move a lot during a conversation. In some exemplary embodiments, setting larger time intervals for measuring directions of arrival may save computational power, battery, processing time, or the like.

Referring now to FIG. 2B showing an exemplary map view, in accordance with some exemplary embodiments of the disclosed subject matter.

In some exemplary embodiments, as depicted in FIG. 2B, Map View 201 may be generated and displayed to the user, e.g., on a display of a mobile device such as Mobile Device 420 of FIG. 4A. In some exemplary embodiments, Map View 201 may depict a location associated with the user, e.g., Location 212, which may comprise a location of a mobile device of the user, a location of a wearable of the user, a location of hearables of the user, or the like. For example, Location 212 may be estimated using a location sensor, a direction of arrival estimation, a triangulation calculation, or the like. In some exemplary embodiments, Map View 201 may depict locations of one or more activated or non-activated entities in the environment of the user, such as Locations 214, 216, and 218. In some cases, the user may be enabled to modify locations of entities, such as by dragging them around Map View 201, e.g., in case their depicted location is inaccurate.

In some exemplary embodiments, in case an identifier of an entity in Map View 201 is known, Map View 201 may depict the identifier, such as by presenting a textual indication of the identifier adjacently to the respective location (denoted ‘Bob’ and ‘Charlie’), by presenting a visual indication of the identifier adjacently to the respective locations (denoted photographs, avatars, or images of Bob and Charlie), or the like. For example, photographs of entities may be automatically extracted from their profile, contact records, social media profile, or the like, and presented in association with the respective locations. In other cases, photographs of entities may be manually captured by the user such as via Mobile Device 420 of FIG. 4A, and presented in Map View 201. In some cases, an object depicted at Location 212, representing the user, may also depict an identifier of the user such as the user's name, image, or the like. In some exemplary embodiments, in case an identifier of an entity in Map View 201 is unknown, the respective object may remain blank, may be populated with a default identifier (e.g., the mask and ‘unidentified’ string at Location 218), or the like. In some cases, in case an identifier of an entity in Map View 201 is unknown, the identifier may be estimated automatically. For example, Location 218 may be associated with an unidentified entity, which may be estimated to be Alice. In such cases, the user may be prompted to confirm or decline the identifier ‘Alice’, the estimated identifier ‘Alice’ may be automatically set, or the like.

In some cases, in case a location of an identified or unidentified entity cannot be determined, the entity may be represented at a predetermined location of Map View 201, of the display of Mobile Device 420 of FIG. 4A, or the like (not depicted), such as at the bottom of the screen of Mobile Device 420 of FIG. 4A. In some cases, background noise or non-human sounds may be indicated visually in Map View 201, such as presenting a predetermined symbol in Map View 201 (not depicted). For example, the predetermined symbol may comprise a cloud at a predetermined location, such as the center of the display, or at any other position.

In some exemplary embodiments, the user may be enabled to activate or mute entities via Map View 201. For example, the user may select an entity by pressing on the respective object in Map View 201, indicating the entity via its identifier or relative position using a vocal command, or the like. A graphical display of selected entities may or may not be adjusted, such as by increasing a width of an outer line of the selected entity (e.g., as depicted with Location 218), or in any other way, e.g., by changing a color of the selected entity. In some exemplary embodiments, selected entities may be muted or activated, such as by selecting the GUI Elements 221 or 223. For example, GUI Elements 221 or 223 may be presented to the user upon selecting Location 218. In other cases, any other manipulation may be performed for selected entities, e.g., enabling the user to change a volume of the selected entity, to change an identifier of the entity, to change its location in Map View 201, or the like.

In some exemplary embodiments, the user may be enabled to add new entities via Map View 201. For example, the user may be enabled to indicate a location of a new entity via Map View 201, causing audio signals from the respective direction of arrival to be captured and analyzed.

Referring now to FIG. 3A showing an exemplary flowchart diagram, in accordance with some exemplary embodiments of the disclosed subject matter.

On Step 310, a first noisy audio signal may be captured from an environment of a user. In some exemplary embodiments, the user may use a mobile device for providing user input. In some exemplary embodiments, the user may have at least one hearing device used for providing audio output to the user. In some exemplary embodiments, the user may be located in a noisy environment, such as in an environment that includes a plurality of entities (human, non-human, or the like), background noise, or the like. For example, the first noisy audio signal may be captured similar to Step 100 of FIG. 1.

On Step 320, the first noisy audio signal may be processed according to a first processing mode, e.g., the ‘several’ processing mode. In some exemplary embodiments, the first processing mode may be configured to apply speech separation, in order to extract separate audio signals for a respective plurality of activated entities (e.g., also referred to as unfiltered entities) that the user wishes to hear.

In some exemplary embodiments, for each activated entity, a separate audio signal that represents the entity may be extracted. For example, a first separate audio signal may be extracted from the first noisy audio signal to represent a first entity, and a second separate audio signal may be extracted from the first noisy audio signal to represent a second entity. In some cases, the first and second separate audio signals may be extracted based on a first acoustic fingerprint of the first entity, and a second acoustic fingerprint of the second entity, respectively. In some cases, the first and second separate audio signals may be extracted based on a direction of arrival associated with the first entity, and a direction of arrival associated with the second entity, respectively, potentially without using acoustic signatures. In some cases, a separate audio signal may be extracted for an activated entity based on a descriptor of the entity (e.g., by applying a description-based model on text or a vocal command provided by the user). For example, the descriptor of the entity may be used by a description-based machine learning model that is trained to extract audio signals according to textual or vocal descriptions, to extract the separate audio signal of the entity. In some cases, the first and second separate audio signals may be extracted based on directions of arrivals of the entities, acoustic fingerprints of the entities, descriptors of the entities, a combination thereof, or the like. In some exemplary embodiments, after extracting separate audio signals for each activated entity that is matched with the first noisy audio signal, the separate audio signals may be processed and combined to obtain a first enhanced audio signal.

In some exemplary embodiments, the first processing mode may be configured not to provide to the user voices of muted entities, sounds of entities that are not activated, background noise, or the like. For example, for an entity that is muted by the user, a separate audio signal of the entity's voice may not be extracted and may not be incorporated into the first enhanced audio signal. According to this example, the first enhanced audio signal may be absent of the voice of the entity.

On Step 330, based on the separate audio signals, one or more audio settings of the user, or the like, the first enhanced audio signal may be generated and outputted to the user. For example, the first enhanced audio signal may be conveyed and played to the user via the at least one hearable device.

On Step 340, based on a user indication, a processing mode may be determined to be changed or switched from the first processing mode to a second processing mode. In some exemplary embodiments, the user indication may comprise an explicit or implicit user indication, determined manually or automatically.

In some exemplary embodiments, the user indication may comprise the activation of a dedicated control on the mobile device for a time period. In some exemplary embodiments, the selection of the dedicated control may cause the first processing mode to be switched with the second processing mode for the time period, and to reinforce the first processing mode when the selection is released. For example, when the user presses and holds a control (e.g., a button) in the user interface of the mobile device or any other user device, the mode of operation may automatically switch to ‘everyone’ mode for the duration that the control is pressed or selected, and revert to ‘several’ mode when the control is released or deselected. The control may be designed in any shape, having any text (if any), and may be activated in any manner (voice control, button click, or the like).

In some exemplary embodiments, temporarily switching the mode to the second mode (the ‘everyone’ mode) may enable the user to easily hear temporary entities such as waiters in a restaurant for short periods of time, without generating for them dedicated profiles, acoustic signatures, or the like, which may be resource consuming. In some exemplary embodiments, switching the mode to the second mode using a single interaction with a dedicated control may provide an enhanced user experience compared to requiring the user to manually change modes twice for each appearance of a temporary entity that the user wishes to hear.

In some exemplary embodiments, the user indication may comprise implicit user input that is determined automatically without manual user input. For example, the user indication may comprise a head movement of the user, a face direction of the user, a speech direction of the user, or the like, which may be identified automatically by a motion detector, an optical tracking system, a microphone array, or the like. For example, in case the user's head or speech moves to a direction that does not correspond to a direction of any activated entity, this may be determined to be the user indication, causing the mode change. As another example, in case the user's head abruptly moves in a new direction in a speed or acceleration that is greater than a threshold, this may be determined to be the user indication, causing the mode change. In some cases, the user indication may comprise implicit user input that is inferred from a conversation of the user, e.g., based on an automatic analysis of a conversation transcript. For example, the user's speech may be converted to text and analyzed semantically, by a Natural Language Processing (NLP) engine, a Large Language Model (LLM) engine, or the like, in order to determine that the user is conversing with a new entity. In some exemplary embodiments, when implicit user input is used as the user indication, subsequent implicit user input may be used to revert to the first processing mode. For example, the first processing mode may be reinforced in response to a second user indication, e.g., a second head movement of the user to a previous position, a second speech direction of the user in a previous angle, a subsequent automatic analysis of speech content, or the like.

In some exemplary embodiments, the user indication may comprise manual settings selections, manual indications, or the like. For example, the user may perform a first manual selection (e.g., using a click, a vocal command, or the like) of the second processing mode via the mobile device, and the first processing mode may be switched back and reinforced in response to a second manual selection of the first processing mode via the mobile device. As another example, the user may provide a command to switch the processing modes, such as by providing a vocal command indicating that the user wishes to hear a new entity (e.g., “I want to hear the waiter”, “I want to hear a baby”). Such commands may be regarded as explicit commands, although they do not refer verbatim to the processing mode. For example, the command may comprise a descriptor of a sound of interest, and a description-based model may be executed on the noisy signal based on the descriptor. As another example, a manual indication may comprise a manual selection of an object or angle on a map view. For example, the object may represent a new entity that is identified based on an angle model (e.g., a dominant direction). As another example, the manual indication may comprise a manual interaction with the hearing device.

In some exemplary embodiments, the first processing mode may be reinforced in response to releasing the selection of the dedicated control, in response to implicit user input such as a head movement in an opposite direction that a previous head movement, implicit user input such as absence of sound from an indicated angle for a defined period, explicit user input such as a command, or the like. In some cases, the first processing mode may be reinforced according to defined settings or configurations, such as defining that the first processing mode should be reinforced after a specified time period elapses. For example, the defined settings or configurations may be set by the user, may comprise default settings, or the like.

On Step 350, a second noisy audio signal may be captured from the environment. In some exemplary embodiments, the second noisy audio signal may be subsequent to the first noisy audio signal, may be a consecutive audio signal, a non-consecutive audio signal, or the like. For example, the second noisy audio signal may be captured before the first processing mode is reinforced, such as during the selection of the dedicated control.

On Step 360, the second noisy audio signal may be processed according to the second processing mode, e.g., the ‘everyone’ mode. In some exemplary embodiments, the second processing mode may be configured to remove a background noise from the second noisy audio signal without performing speech separation, without extracting separate audio signals for activated entities, or the like, in contrast to the first processing mode. In some exemplary embodiments, applying the second processing mode may produce or generate a background-filtered second noisy audio signal, that includes all voices and sounds of entities that are not deemed to be background noise.

On Step 370, based on the background-filtered second noisy audio signal, a second enhanced audio signal may be generated and outputted to the user. For example, the second enhanced audio signal may incorporate the voice of muted entities, of unknown or temporary entities, or the like, in addition to voices of activated entities.

In some exemplary embodiments, the first enhanced audio signal that was generated before the mode change, may incorporate voices of a first number of entities, e.g., activated entities that are present within the first noisy audio signal. In some exemplary embodiments, the second enhanced audio signal that is generated using the second processing mode (e.g., during the selection of the control) may incorporate voices of a greater number of entities, e.g., a second number of entity voices that is greater than the first number. For example, the second number of entity voices may comprise all voices in the user's environment, including activated entities, muted entities that were muted by the user, unknown entities, or the like. In some exemplary embodiments, a subsequent enhanced audio signal that is generated after reinforcing the first processing mode, may again incorporate voices of the first number of entities, e.g., only the activated entities.

In some exemplary embodiments, after generating the second enhanced audio signal, the second enhanced audio signal may be outputted via the at least one hearable device and consumed by the user.

In some exemplary embodiments, a smooth transition may be implemented between the first processing mode and the second processing mode (in case they are consecutive) during an overlapping cross-fade period. In some exemplary embodiments, during the cross-fade period, a volume of the first enhanced audio signal may be gradually decreased while a volume of the second enhanced audio signal may be gradually increased. In some exemplary embodiments, portions of the first and second enhanced audio signals may be briefly heard together, by the user, during the cross-fade period.

In some scenarios, the second processing mode may be activated, by default, before the first processing mode is activated, such as upon activation of a software application implementing the disclosed subject matter. For example, the ‘everyone’ mode may be executed until the user selects one or more activated entities, muted entities, or the like. According to this example, the method of FIG. 3A may be executed after the user selection. In some scenarios, a third processing mode may be activated by default before the first processing mode is activated. For example, the third processing mode, also referred to as ‘everyone but the user’, may correspond to the ‘everyone’ mode, in which the user's own voice is attenuated. For example, the voice of the user may be separated and filtered out from the enhanced audio signal, vocal waves originating from the user's DoA may not be processed, or the like. According to this example, the ‘everyone but the user’ mode may be executed until the user selects one or more activated or muted entities. In other cases, the first processing mode may be executed by default, e.g., by activating or muting one or more entities according to default configurations, rules, conditions, settings, or the like. It is noted that in some cases, different processing modes may have different latencies.

Referring now to FIG. 3B showing an exemplary flowchart diagram, in accordance with some exemplary embodiments of the disclosed subject matter.

On Step 315, an intention of a user may be estimated, determined, or the like, in an environment of the user. In some exemplary embodiments, the user may be estimated to have an intention to hear (e.g., to activate) an unknown entity. In some exemplary embodiments, activating an entity may refer to including a voice of the entity in the audio output that is provided to the user, thereby enabling the user to hear the entity. In some exemplary embodiments, the user may intend to activate an unknown entity in case the user wishes to hear a new person, such as a temporary entity, a friend, or the like, that is speaking with the user and is not activated, not identified, or the like.

In some exemplary embodiments, the user may be determined to have an intention to activate the unknown entity based on a user indication. In some exemplary embodiments, the user indication may comprise implicit user input, explicit user input, or the like, which may be provided manually or determined automatically. In some exemplary embodiments, the intention of the user may be estimated based on explicit indications of the user (e.g., a vocal command, a manual selection or gesture, or the like), or implicitly (e.g., based on tracked behavior of the user, a transcript of the user's speech). For example, names used in a transcript may be mapped to profiles with acoustic signatures, and the user may be determined to have an intention to activate these profiles.

In some exemplary embodiments, the user indication may comprise implicit user input that is determined automatically without explicit instructions from the user. For example, the user may be estimated to desire to hear the unknown entity based on an analysis of activity of the user, e.g., constituting the user indication. In some cases, the user may be estimated to desire to hear a muted entity based on an analysis of activity of the user. In some exemplary embodiments, the analysis of the activity of the user may comprise an analysis of tracked user behavior such as a head movement of the user, a face direction of the user, a change in a speech direction of the user, or the like, which may be identified automatically by a motion detector, an optical tracking system, a microphone array, or the like. As another example, the intention of a user may be estimated based on an automatic analysis of speech content of the user, e.g., the user using a name of an entity that is not associated to any active entity, greeting a new entity, or the like.

In some exemplary embodiments, the user's motions and/or speech may be tracked and analyzed to identify abrupt changes in direction, angles that do not correspond to directions of activated entities, or the like. In some exemplary embodiments, the user's speech direction may be tracked, such as using a microphone array, a beamforming microphone system, an acoustic localization system, a sound triangulation system, a DoA measurer, or the like. For example, one or more trackers may be used to track the user's head movements, face direction, speech direction, or the like. In some cases, in case an angle to which the user moves their head or speaks to, does not correspond to a direction of any activated entity, the user's intention to converse with a new entity may be determined. As another example, in case the user's head moves in a new direction in a speed or acceleration that exceeds a threshold, that is sharper than a threshold, or the like, the user's intention to converse with a new entity may be determined. In some cases, one or more priority scores may be assigned to entities in the vicinity of the user based on the tracked user motions, and used to adjust the amplification of the entities' voices accordingly.

In some exemplary embodiments, the user indication may comprise explicit user input that is expressed manually. For example, the explicit user input to the mobile device may comprise holding the mobile device along or in parallel to a line connecting the user and the unknown entity. As another example, the explicit user input to a user device may comprise a selection of a relative location or angle between the user and the unknown entity via a map view that is rendered on the user device. As another example, the explicit user input to a user device may comprise a selection of a ‘press and hold’ control, or any other dedicated control, on the user device. As another example, the explicit user input may comprise a gesture on a hearing device of the user, such as the hearables. For example, the user may perform a manual interaction with the hearing device, signaling their intent to listen to a sequential sound (e.g., in close proximity on the time axis), to listen to a sound from an unknown source, or the like.

In some cases, a map view may be displayed to the user, via the mobile device, e.g., corresponding to the map view of FIG. 2B. The map view may depict locations of one or more entities relative to a location of the mobile device. In some exemplary embodiments, the indication of the relative location may be received via the mobile device, via the map view, or the like. For example, the user may select an angle between an entity and the user device, or a relative location of an entity, via the map view. As another example, the map view may depict entities based on one or more dominant DoAs identified by an angle model.

On Step 325, an angle between the user and the unknown entity may be determined, e.g., based on the user indication, dominant DoAs, or the like. For example, in case the user indication comprises user behavior, the angle may be determined to correspond to a new angle to which the user directs their head, speech, or the like (e.g., in case the new angle corresponds to a dominant DoA). As another example, in case the user indication comprises a user selection of an angle, relative location of the unknown entity with respect to the user, or object representing the unknown entity in a map view, the angle may comprise the obtained angle. In other cases, the angle may be determined irrespective of the user indication, e.g., based on a new dominant stream of speech.

In some cases, before the user indication, one or more calculations may be executed in the background in order to enable the user to activate unknown entities with increased speed. For example, angles of unknown entities may be identified (e.g., according to the user's head or speech direction) before the user indication is determined, and used for generating acoustic fingerprints of the entity, thereby reducing a time delay of activating the unknown entity.

On Step 335, a noisy audio signal may be captured from the environment, e.g., similar to Step 310 of FIG. 3A.

On Step 345, the noisy audio signal may be processed, and an enhanced audio signal may be generated based thereon. In some exemplary embodiments, the enhanced audio signal may be generated to incorporate the voice of the unknown entity. In some exemplary embodiments, the enhanced audio signal may be generated by processing the noisy audio signal to extract a separate audio signal that represents the unknown entity therefrom, e.g., based on an angle between the user and the unknown entity.

In some cases, an angle between the user and the unknown entity may be determined based on a dominant DoA detected by an angle model. In some cases, an angle between the user and the unknown entity may be determined based on detected motions of the user, e.g., identifying that the user faces the angle. In some cases, an angle between the user and the unknown entity may be obtained from a user, such as by obtaining a selection of an angle via a map view. For example, the map view may depict, on a user device, a circle representing 360 degrees around the user's location, and the user may select the angle of the entity. As another example, the map view may depict objects representing unknown entities with dominant DoAs, and the user may select an object of the entity, thereby providing the angle indirectly.

In some cases, a DoA of the speech from the unknown entity may be used to extract the separate audio signal, e.g., without necessarily utilizing acoustic signatures. In some cases, one or more models may be employed to extract the separate audio signal from the noisy audio signal, e.g., based on the DoA, an acoustic signature, or the like. For example, the models may comprise a generative model, a discriminative model, a beamforming model, or the like. In some cases, each model may be associated with an angle or a range of angles.

In some cases, based on the angle, an acoustic signature of the unknown entity may be generated, such as from audio streams arriving from the angle. In some exemplary embodiments, the separate audio signal may be extracted from the noisy audio signal based on the acoustic signature. In some cases, at a first stage, the acoustic signature may be generated and used to extract the separate audio signal, and at a second stage, a DoA associated with the sound that was matched to the signature, may be used to extract subsequent separate audio signals. In some cases, a DoA of a dominant angle may be used at a first stage to extract the separate audio signal, and at a second stage, the DoA may be used to generate an acoustic signature of the entity and execute the acoustic signature on subsequent signals. In some cases, the acoustic signature may be used in combination with the DOA, in one or more overlapping or sequential timeframes. In other cases, any other combination of DoA and acoustic signature may be used in any other order, simultaneously, or the like, for extracting the separate audio signal from the noisy audio signal.

In some exemplary embodiments, a temporary profile may be dynamically generated for the unknown entity, and the profile may be activated, opt-in, or the like. In some exemplary embodiments, temporary profiles may become permanent, such as in case the timeframe during which the profile of the unknown entity is activated is longer than a time threshold, in case the user manually saves the temporary profile as a permanent profile (e.g., potentially providing an identifier thereof), or the like. In some cases, the time threshold may be static or may be determined dynamically based on the context, type of event, or the like. In some cases, the user may be prompted to save the profile permanently or discard the profile, to save the acoustic signature of the unknown entity within the profile, to provide an identifier of the temporary entity, or the like.

On Step 355, the enhanced audio signal may be outputted to the user via the at least one hearable device.

Referring now to FIG. 4A showing an exemplary environment in which the disclosed subject matter may be utilized, in accordance with some exemplary embodiments of the disclosed subject matter.

In some exemplary embodiments, Environment 400 may comprise one or more Microphones 410. In some cases, Microphones 410 may comprise a microphone array that comprises a plurality of microphones, which may be strategically placed to capture sound from different sources or locations. In some cases, Microphones 410 may comprise a multi-port microphone for capturing multiple audio signals. In some cases, Microphones 410 may comprise a single microphone. In some exemplary embodiments, the microphones may comprise one or more microphone types. For example, the microphones may comprise directional microphones that are sensitive to picking up sounds in certain directions, unidirectional microphones that are designed to pick up sound from a single direction or small range of directions, bidirectional microphones that are designed to pick up sound from two directions, cardioid microphones that are sensitive to sounds from the front and sides, omnidirectional microphones that pick up sound with equal gain from all sides or directions, or the like.

In some exemplary embodiments, Environment 400 may comprise a Mobile Device 420. In some exemplary embodiments, Mobile Device 420 may comprise a mobile device of the user such as a smartphone, a Personal Computer (PC), a tablet, an end device, or the like.

In some exemplary embodiments, Environment 400 may comprise a Server 430, which may communicate with Mobile Device 420 via one or more communication mediums, such as Medium 405.

For example, Medium 405 may comprise a wireless and/or wired network such as, for example, a telephone network, an extranet, an intranet, the Internet, satellite communications, off-line communications, wireless communications, transponder communications, a local area network (LAN), a wide area network (WAN), a virtual private network (VPN), or the like. In some exemplary embodiments, Medium 405 may utilize any known wireless standard (e.g., Wi-Fi, Bluetooth™, LE-Audio, or the like), near-field capacitive coupling, short range wireless techniques, physical connection protocols such as Lightning™, or the like. In some exemplary embodiments, Medium 405 may comprise a shared, public, or private network, a wide area network or local area network, and may be implemented through any suitable combination of wired and/or wireless communication networks. In some exemplary embodiments, Medium 405 may comprise a short range or near-field wireless communication systems for enabling communication Mobile Device 420 and Microphones 410. In some exemplary embodiments, Medium 405 may enable communications between Microphones 410, Mobile Device 420, Server 430, Hearables 440, or the like.

In some exemplary embodiments, Environment 400 may comprise Hearables 440, which may comprise headphones, wired earplugs, wireless earplugs, a Bluetooth™ headset, a bone conduction headphone, electronic in-car devices, in-ear buds, or the like.

In some cases, a processing unit may comprise one or more integrated circuits, microchips, microcontrollers, microprocessors, one or more portions of a Central Processing Unit (CPU), Graphics Processing Unit (GPU), Digital Signal Processing (DSP), Field-Programmable Gate Array (FPGA), Inertial Measurement Unit (IMU), or other circuits suitable for executing instructions or performing logic operations. The instructions executed by the processing unit may, for example, be pre-loaded into a memory that is integrated with the processing unit, pre-loaded into a memory that is embedded into the processing unit, may be stored in a separate memory, or the like. In some exemplary embodiments, the processing unit may be integrated with Microphones 410, Mobile Device 420, Server 430, Hearables 440, a combination thereof, or the like. In some exemplary embodiments, the functionality of the processing unit may be distributed between two or more of Microphones 410, Mobile Device 420, Server 430, and Hearables 440. For example, the processing unit may be integrated in two or more devices, causing some processing of the processing unit to be performed at one device (e.g., Mobile Device 420), and other processing of the processing unit to be performed at a different device (e.g., Server 430). As another example, the processing unit may be integrated into a single device, e.g., Mobile Device 420. In some exemplary embodiments, the processing unit may be configured to obtain captured audio signals from Microphones 410, or from any other source such as from a different microphone array, from Server 430, or the like.

Referring now to FIG. 4B showing an exemplary scenario of utilizing the disclosed subject matter, in accordance with some exemplary embodiments of the disclosed subject matter.

In some exemplary embodiments, FIG. 4B depicts a non-limiting scenario of implementing the disclosed subject matter, that may be performed in the environment of FIG. 4A. In some exemplary embodiments, the non-limiting scenario of FIG. 4B may be performed in case a user of Mobile Device 420 activates a program or another executable unit associated with the disclosed subject matter, in case a user of Hearables 440 activates the program, in case the program is activated automatically, e.g., when the user is estimated to be in a noisy situation, or the like.

In some exemplary embodiments, one or more entities in the environment of the user may be activated. For example, the entities may be activated in response to obtaining activation indications from the user via Mobile Device 420 or Hearables 440, from Server 430, or the like. As another example, all entities may be activated before a user activation indication is obtained, and in response to obtaining the activation indication, the remaining entities may be deactivated. For example, activating all entities may comprise activating all profiles of entities that are stored for the user, configuring the processing unit to separate all voices in the noisy audio signal and apply available signatures thereto, or the like. As another example, a defined set of entities may be activated as a default setting, and the user may adjust the set of entities that are activated, e.g., via Mobile Device 420.

In some exemplary embodiments, Microphones 410 may be configured to capture one or more audio channels in a noisy environment of the user, thereby obtaining a noisy audio signal with a set duration. For example, Microphones 410 may iteratively capture audio signals with a duration of 5 milliseconds (ms), 10 ms, 20 ms, 30 ms, or the like. In some exemplary embodiments, the number of channels captured by Microphones 410 may correspond to a number of microphones in the microphone array of Microphones 410. For example, in case Microphones 410 comprises an array of three microphones, three respective audio channels may be captured by Microphones 410. The audio channels may be captured simultaneously, in at least partially overlapping time periods, with one or more delays between channels that are lesser than a specified delay threshold, or the like. In some exemplary embodiments, at least some of the audio channels captured by Microphones 410 may be provided to the processing unit, e.g., via Medium 405, via a Lightning connector, a USB-C connector, an MFI connector, or the like.

In some exemplary embodiments, the processing unit may convert the noisy audio signal from the time domain to the frequency domain, such as by applying STFT 422, or any other transformation, on the noisy audio signal. For example, the noisy audio signal may be transformed using learnable time-frequency features, using a trained CNN model, or the like. In other cases, the noisy audio signal may be utilized without being transformed to the frequency domain, at least a portion of the noisy audio signal may be utilized without being transformed to the frequency domain, or the like. In some exemplary embodiments, audio channels captured by different microphones, may or may not be processed separately by STFT 422. For example, in case Microphones 410 captured three audio channels, STFT 422 may be applied to each channel separately, resulting with at least one converted audio channel. In some cases, STFT 422 may be applied on two or more channels simultaneously.

In some exemplary embodiments, at least a portion the converted noisy audio signal may be provided for processing to Speech Separation 424, Verification 426, Signature Generator 432, DOA 434, or the like. In some exemplary embodiments, some processing models may be entity-specific, and may be utilized for each activated entity. For example, models within Processing Operations 451 may be performed separately for each activated entity. In such cases, models within Processing Operations 451 may be applied on the converted noisy audio signal for each activated entity, separately. In other cases, STFT 422 and DOA 434 may also be entity-specific, e.g., applied separately on the converted noisy audio signal for each activated entity. In other cases, some models within Processing Operations 451 may not be entity-specific, and may be applied for multiple entities. The models may or may not be personalized using acoustic fingerprints, using directionality (using a DoA), or the like. The models may or may not be fed by multiple microphones, and may or may not be applied on multiple entities simultaneously. In some exemplary embodiments, some models may be executed over a different number of channels for different activated entities. For example, Verification 426 may be executed on a single channel (e.g., of a selected microphone) for a first activated entity, and on a plurality of channels for a second activated entity (e.g., upon obtaining a DoA for the second activated entity).

In some exemplary embodiments, one or more channels of the converted noisy audio signal may be provided to Speech Separation 424, which may comprise an entity-specific model such as a machine learning model, a DSP-based model, a sound retrieval model that is trained to retrieve sounds according to textual descriptions, a deep learning classifier, a supervised or unsupervised neural network, a combination thereof, or the like. For example, at least one channel of the converted noisy audio signal may be provided to Speech Separation 424. In some exemplary embodiments, Speech Separation 424 may obtain an acoustic signature of an activated entity, and extract from the converted noisy audio signal, a separated voice of the entity, e.g., as an audio signal, a stereo audio, a mono channel, a simulated stereo audio, or the like. In other cases, Speech Separation 424 may not be performed on a single entity, and may be trained to extract multiple voices associated with multiple input acoustic signatures.

In some exemplary embodiments, a verification module such as Verification 426 may verify that the activated entity, for which the separated voice is extracted by Speech Separation 424, has a vocal presence in the converted noisy audio signal from STFT 422. For example, this may indicate whether Speech Separation 424 functioned correctly. In some exemplary embodiments, Verification 426 may obtain one or more channels of the converted noisy audio signal (e.g., three channels thereof), obtain the acoustic signature of the activated entity, and determine whether or not the converted noisy audio signal comprises sound that matches the received acoustic signature. In some exemplary embodiments, Verification 426 may operate without an acoustic signature, such as by obtaining one or more channels of the converted noisy audio signal (e.g., three channels thereof), a direction of interest (DOI) associated with the entity, or the like, and determine whether or not the converted noisy audio signal matches the direction of interest. For example, in case a beam associated with the DoI angle is sufficiently narrow (complies with a threshold), Verification 426 may operate without utilizing the acoustic signature, based on directionality alone. In some cases, Verification 426 may use the acoustic signature to identify a directionality of an entity, and then operate based on the directionality.

In some exemplary embodiments, Verification 426 may process all the channels of the converted noisy audio signal (multi-channel), or process a portion thereof. For example, in case Verification 426 obtains a DoI from DOA 434, from a user, or the like, Verification 426 may process three channels of the converted noisy audio signal, and in case Verification 426 does not obtain a DoI indication (e.g., at a beginning of the session), Verification 426 may process a single channel (mono-channel) of the converted noisy audio signal. In some exemplary embodiments, Verification 426 may utilize the DoI angle to further verify the presence of the respective entity, to identify an incorrect matching of a signature to an audio signal (e.g., in case of similar voices in the environment), or the like. In some cases, the DoI angle may be utilized to verify separated voice in addition to or instead of using the signature. In some exemplary embodiments, Verification 426 may comprise a Voice Activity Detection (VAD) model, a sound activity detection, a data-driven model, or any other model.

In some exemplary embodiments, Verification 426 may generate a value for Filtration Mask 428, such as a value of zero for a failure of matching the acoustic signature with the noisy audio signal, and a value of one for successfully matching the acoustic signature with the noisy audio signal. In other cases, Verification 426 may generate a continuous variable for Filtration Mask 428, such as a value between zero and one. For example, such values may be clustered to zero or one, and outputted as Filtration Mask 428. In some exemplary embodiments, Filtration Mask 428 may be multiplied with the separated voice of the target entity that is extracted by Speech Separation 424, thus nullifying or eliminating the separated voice in case Filtration Mask 428 has a value of zero, and retaining the separated voice in case Filtration Mask 428 has a value of one.

In some embodiments, the signature generated by Signature Generator 432, and/or the output of Speech Separation 424 may be provided to DoA 434, in order to verify that the detected angle of arrival is associated with the correct entity, as detailed below.

In some exemplary embodiments, after all activated entities are processed in this way, the separated voices of the entities may be combined, accumulated, or the like, and provided to Hearables 440. For example, the separated voices may be provided to Accumulate Sounds 441, which may accumulate the sounds. Sounds that were nullified by Filtration Mask 428 may not have a vocal presence in the accumulate audio signal that is outputted from Accumulate Sounds 441. In some exemplary embodiments, in case the noisy audio signal was converted to the frequency domain, Inverse STFT (ISTFT) 443 may be applied to the accumulate audio signal from Accumulate Sounds 441, such as in order to convert the signal back from the frequency domain to the time domain, before providing the resulting audio signal to Hearables 440. In some exemplary embodiments, the separated voices of the entities may be combined at the processing unit, at Hearables 440, at Mobile Device 420, or the like. In some cases, ISTFT 443 may not be applied to a model that was not transformed to the frequency domain. For example, Processing Operations 451 may comprise a combination of models, including some generative models, some discriminative models, or the like, some of which may operate on one or more channels in the time domain, while others may operate on one or more channels in the frequency domain. According to this example, for models operating in the time domain, neither STFT 422 nor ISTFT 443 may be applied.

In some exemplary embodiments, an online workflow may refer to all operations that are necessarily performed for each noisy signal captured by Microphones 410. In some exemplary embodiments, the online workflow may comprise STFT 422, Speech Separation 424, Verification 426, Filtration Mask 428, Accumulate Sounds 441, and ISTFT 443. In some exemplary embodiments, the operations of the online workflow may be required to have, together, a limited latency threshold such that the user may be enabled to participate in a conversation using the processed outputs from the online workflow. For example, an overall delay that is greater than two seconds may not enable the user to participant in a conversation comfortably.

In some exemplary embodiments, some operations may be performed as part of an offline workflow, which may not necessarily be fully performed and computed for each noisy signal that is captured by Microphones 410, which may not necessarily provide an immediate output for each noisy signal, or the like. For example, Signature Generator 432 and DOA 434 may be part of the offline workflow, and may not provide an output for each noisy signal. In some cases, a model may require calculations that take more time than the latency threshold of the online workflow, e.g., a minute, and thus may not be executed as part of the online workflow. In some cases, DOA 434 may perform complex computations that may not necessarily comply with the latency threshold of the online workflow, may require a longer lookahead than models that participate in the online workflow, or the like. For example, DOA 434 may not be able to compute a DoA of an activated entity during an initial time duration from the activation of DOA 434, causing Verification 426 to be activated without having an estimated DoI of a respective entity. In some cases, after the initial time duration, an initial DoA of the respective entity may be computed, and provided to Verification 426 as a DoI.

In some exemplary embodiments, DOA 434 may be configured to obtain one or more channels of the noisy audio signal (e.g., three channels), obtain a separated voice from Speech Separation 424, the acoustic signature of the respective entity, or the like, and output a scalar, such as a value between the range of [−180, +180] degrees, that indicates the DoA of the Sol, a range thereof, or the like. In some exemplary embodiments, the DoA may be defined in relation to a predefined anchor, location point, or the like, such as with respect to a location of Microphones 410, a location of Mobile Device 420, a location of Hearables 440, a line parallel to the processing unit, or the like. In some cases, DOA 434 may comprise a beamforming receiver array, a learnable probabilistic model, a Time Difference of Arrival (TDoA) model, a data-driven model such as a CNN, a RNN, a Residual Neural Network (ResNet), a Transformer, a Conformer, or the like. In other cases, instead of measuring the DoA of the Sol, DOA 434 may obtain an indication of the DoA from the user, from Server 430, or the like.

In some exemplary embodiments, DOA 434 may search for one or more dominant directions in the noisy audio signal, such as by applying beamforming processing on each degree, one or more bins of degrees or the like. In some exemplary embodiments, for each measured degree or bin, a score may be calculated. For example, in case beamforming processing is applied on all degrees, 360 scores may be obtained (one score for each degree). As another example, in case beamforming processing is applied on bins of two or more degrees, e.g., 36 degrees, 10 scores may be obtained (one for each 36 degrees). In some exemplary embodiments, one or more directions with scores that exceed a threshold may be determined as dominant directions. In some cases, in case that a direction is dominant, the respective degree may be selected and provided to the verification within DOA 434 as a constraint, e.g., a DoI constraint. In some exemplary embodiments, in case no degree is estimated to be dominant (having a score that exceeds a threshold, or having a score that is similar to neighboring degrees), such as during a quiet moment of a conversation, DOA 434 may provide no value, a Null value, return ‘False’, may terminate, or the like.

In some exemplary embodiments, in case a dominant direction is determined, DOA 434 may perform a verification step prior to providing the DoI to Verification 426, e.g., within DOA 434. For example, DOA 434 may obtain the acoustic signature of the respective entity, and determine whether the separated voice from Speech Separation 424 matches the acoustic signature. In some exemplary embodiments, in case the verification is successful, the dominant angle may be estimated to be associated with the respective entity, e.g., since the entity speaks in the respective time duration. In some exemplary embodiments, in case the verification fails, the dominant direction may be disregarded, and may not be provided to Verification 426. In other cases, the verification step may be performed prior to estimating a dominant direction. In some cases, in case a dominant direction is determined, a configuration of Speech Separation 424 may be adjusted to process a plurality of audio channels, together with a DoI from DOA 434 that corresponds to the dominant direction, the acoustic signature, or the like. For example, before obtaining the DoI, Speech Separation 424 may be configured to process a single audio channel.

In some exemplary embodiments, after DOA 434 is activated, it may or may not be operated continuously, periodically, or the like. For example, DOA 434 may be applied every determined time period for activated entities, e.g., to save computational power. In some cases, DOA 434 may determine angles for non-activated entities in the environment, e.g., every longer time period. For example, DoAs of activated entities may be calculated more frequently than DoAs of non-activated entities. In some cases, DOA 434 may determine angles for non-activated entities, e.g., in case they are identified in the environment, so that in case the non-activated entities are activated by the user, Verification 426 may obtain a DoI immediately, without waiting for a new calculation of DOA 434. For example, the DoI may comprise the most recent DoI that was computed for the entity.

In some exemplary embodiments, Signature Generator 432 may be configured to obtain one or more channels of the noisy audio signal (e.g., three channels), obtain the acoustic signature of the respective entity, or the like. In some exemplary embodiments, Signature Generator 432 may be configured to adjust or modify the acoustic signature according to the noisy audio signal, e.g., to be more accurate. For example, the acoustic signature of an entity that was generated based on one or more audio records of the entity, may be adjusted to be generated based on a portion of the noisy signal that is spoken by the entity, alone or in combination with the previous audio records of the entity. In some cases, Signature Generator 432 may generate one or more acoustic signatures on-the-fly, such as based on vocal records that are dynamically obtained during a conversation of the user. In some exemplary embodiments, Signature Generator 432 may be configured to obtain one or more acoustic signatures from Mobile Device 420, Server 430, or the like, and provide acoustic signatures to any model that requests an acoustic signature. In some cases, Signature Generator 432 may obtain one or more DoAs from DOA 434, such as in order to verify that the noisy signal is associated with the correct entity, before adjusting an acoustic signature of the entity.

In some exemplary embodiments, as part of the online workflow, the separated audio signals, as outputted from Filtration Mask 428, may be processed. For example, the separated audio signals may be accumulated, e.g., as part of Accumulate Sounds 441. Accumulate Sounds 441 may be configured to ensure that the accumulated sounds are not greater than a threshold (e.g., a Maximal Possible Output (MPO)), so that the output signal is not louder than desired. For example, due to the independency of the separated audio signals, the sum of the accumulated sounds may be greater than the captured noisy signal. Accumulate Sounds 441 may bound the volume of the output signal to comprise a certain proportion of the volume of the noisy audio signal, e.g., 100%, 110%, or the like.

In some exemplary embodiments, the accumulated separated audio signals may be processed to mix therein a proportion of background noise, e.g., as defined by the user, by a default setting, or the like. For example, a user may indicate via a user interface that she wishes to preserve 30% of the environment background noise, causing the accumulated separated audio signals to constitute the remaining 70%. In some cases, the environment background noise may be augmented with one or more additional sounds, such as notifications or alerts of Mobile Device 420, which may not be part of the user's environment and may be provided directly to the processing unit. In some cases, the background noise may be defined to include only sounds from Mobile Device 420, and no environment noise.

In some exemplary embodiments, the mixed audio signal may be converted with ISTFT 443, and processed in any other way, such as by wrapping the signal, compressing the signal, or the like, thereby obtaining an output audio signal that can be transmitted to Hearables 440. For example, further processing may comprise applying a Multi Band (MB) compressor, applying a Low Complexity Communication Codec (LC3) compressor, applying any other audio compression, applying one or more expansion units, DSPs, Pulse-Code Modulations (PCMs), equalizers, limiters, signal smoothers, performing one or more adjustment to an audiogram of the user, or the like.

In some exemplary embodiments, the output audio signal may be transmitted to Hearables 440, e.g., via Medium 405. In some exemplary embodiments, Hearables 440 may process the output audio signal and synthesize the output audio signal using one or more speakers, so that the user will be enabled to hear desired sounds. In case the user is not satisfied with one or more sounds, the user may activate or deactivate one or more entities, modify a volume of each activated entity, or the like.

In some exemplary embodiments, any of the communications described in this scenario may be implemented via Medium 405. In some cases, Server 430 may be omitted from the scenario, may be used to provide acoustic fingerprints, may be utilized for offline computations, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
capturing a first noisy audio signal from an environment of a user, the user having at least one hearing device used for providing audio output to the user;
generating, based on the first noisy audio signal, a first enhanced audio signal, said generating the first enhanced audio signal is performed by implementing a first processing mode, the first processing mode is configured to apply sound separation to the first noisy audio signal, whereby at least one sound from an entity is filtered out from the first enhanced audio signal;
outputting to the user, via the at least one hearing device, the first enhanced audio signal;
in response to a user indication, changing a processing mode from the first processing mode to a second processing mode;
capturing a second noisy audio signal from the environment;
generating, based on the second noisy audio signal, a second enhanced audio signal, said generating the second enhanced audio signal is performed by implementing the second processing mode, the second processing mode is configured not to apply the sound separation, whereby sounds from a plurality of entities in the environment remain unfiltered in the second enhanced audio signal, the plurality of entities comprises the entity; and
outputting to the user, via the at least one hearing device, the second enhanced audio signal.

2. The method of claim 1, wherein the user indication comprises a selection by the user of a control on a mobile device of the user for a time period, wherein the selection causes the first processing mode to be switched with the second processing mode during the time period, wherein in response to the user releasing the selection of the control, the method comprises changing the processing mode from the second processing mode back to the first processing mode.

3. The method of claim 2, wherein:
before the selection of the control, the first enhanced audio signal incorporated sounds of a first number of entities;
during the selection of the control, the second enhanced audio signal incorporated sounds of a second number of entities, the second number of entities greater than the first number of entities; and
after the selection of the control, a subsequent enhanced audio signal that is outputted to the user incorporated the sounds of the first number of entities.

4. The method of claim 3, wherein the second number of entities comprises at least a sum of: a number of one or more unfiltered entities that were activated by the user, a number of one or more muted entities that were muted by the user, and a number of unknown entities, wherein the subsequent enhanced audio signal excludes sounds of the one or more muted entities.

5. The method of claim 1, wherein said generating the first enhanced audio signal comprises:
extracting a first separate audio signal from the first noisy audio signal to represent a first entity of the plurality of entities, said extracting is performed based on a first acoustic fingerprint of the first entity;
extracting a second separate audio signal from the first noisy audio signal to represent a second entity of the plurality of entities, said extracting is performed based on a second acoustic fingerprint of the second entity; and
combining the first and second separate audio signals to generate the first enhanced audio signal.

6. The method of claim 5, wherein the entity is muted by the user, wherein the first noisy audio signal comprises a sound of the entity, wherein the first enhanced audio signal is absent of the sound of the entity, and the second enhanced audio signal incorporates the sound of the entity.

7. The method of claim 1, wherein said generating the first enhanced audio signal comprises:
extracting a first separate audio signal from the first noisy audio signal to represent a first entity of the plurality of entities, said extracting is performed based on a direction of arrival associated with the first entity;
extracting a second separate audio signal from the first noisy audio signal to represent a second entity of the plurality of entities, said extracting is performed based on a direction of arrival associated with the second entity; and
combining the first and second separate audio signals to obtain the first enhanced audio signal.

8. The method of claim 1, wherein said generating the first enhanced audio signal comprises:
extracting a first separate audio signal from the first noisy audio signal to represent a first entity of the plurality of entities, said extracting is performed based on a first acoustic fingerprint of the first entity;
extracting a second separate audio signal from the first noisy audio signal to represent a second entity of the plurality of entities, said extracting is performed based on a direction of arrival associated with the second entity; and
combining the first and second separate audio signals to obtain the first enhanced audio signal.

9. The method of claim 1, wherein said generating the first enhanced audio signal comprises:
extracting a first separate audio signal from the first noisy audio signal to represent a first entity of the plurality of entities, said extracting is performed based on a descriptor of the first entity, wherein said extracting is performed by a machine learning model that is trained to extract audio signals according to textual or vocal descriptors; and
generating the first enhanced audio signal to incorporate the first separate audio signal.

10. The method of claim 1, wherein the user indication is identified automatically without explicit user input, wherein the user indication comprises at least one of: a head movement of the user, or a sound direction of the user.

11. The method of claim 10, wherein the user is surrounded by one or more unfiltered entities of the plurality of entities, the first processing mode is configured to include sounds emitted by the one or more unfiltered entities in the first enhanced audio signal, wherein the user indication is indicative of the user directing attention to a direction that does not match directions of any of the one or more unfiltered entities.

12. The method of claim 10, wherein the user indication is identified automatically based on at least one of: a motion detector, an optical tracking system, and a microphone array.

13. The method of claim 10, wherein the processing mode is changed back from the second processing mode to the first processing mode in response to a second user indication, the second user indication comprises at least one of: a second head movement of the user, and a second sound direction of the user.

14. The method of claim 1, wherein the user indication is identified automatically without explicit user input, wherein the user indication comprises an automatic semantic analysis of a transcript of user speech.

15. The method of claim 14, wherein the processing mode is changed back from the second processing mode to the first processing mode in response to a second user indication, the second user indication comprises a second semantic analysis of subsequent user speech.

16. The method of claim 1, wherein the user indication is a vocal command or a manual interaction with the hearing device.

17. The method of claim 1 further comprising performing a smooth transition between the first processing mode and the second processing mode during an overlapping cross-fade period, wherein during the cross-fade period, a volume of the first enhanced audio signal is gradually decreased while a volume of the second enhanced audio signal is gradually increased, whereby portions of the first and second enhanced audio signals are briefly heard together during the cross-fade period.

18. The method of claim 1, wherein the user indication comprises a first manual selection of the second processing mode via the mobile device, wherein the processing mode is changed back from the second processing mode to the first processing mode in response to a second manual selection of the first processing mode via the mobile device.

19. The method of claim 1, wherein the second processing mode is configured to remove a background noise from the second noisy audio signal without applying the sound separation.

20. A computer program product comprising a non-transitory computer readable medium retaining program instructions, which program instructions, when read by a processor, cause the processor to perform:
capturing a first noisy audio signal from an environment of a user, the user having at least one hearing device used for providing audio output to the user;
generating, based on the first noisy audio signal, a first enhanced audio signal, said generating the first enhanced audio signal is performed by implementing a first processing mode, the first processing mode is configured to apply sound separation to the first noisy audio signal, whereby at least one sound from an entity is filtered out from the first enhanced audio signal;
outputting to the user, via the at least one hearing device, the first enhanced audio signal;
in response to a user indication, changing a processing mode from the first processing mode to a second processing mode;
capturing a second noisy audio signal from the environment;
generating, based on the second noisy audio signal, a second enhanced audio signal, said generating the second enhanced audio signal is performed by implementing the second processing mode, the second processing mode is configured not to apply the sound separation, whereby sounds from a plurality of entities in the environment remains unfiltered in the second enhanced audio signal, the plurality of entities comprises the entity; and
outputting to the user, via the at least one hearing device, the second enhanced audio signal.

21. The computer program product of claim 20, wherein the user indication comprises a selection of an object in a map view presented by the mobile device, wherein the object represents the entity, wherein a relative location of the object with respect to the mobile device is determined based on a direction of arrival associated with the entity.

22. A method comprising:
determining that a user has an intention to hear an unknown entity, the user utilizing a hearing system that includes at least one hearing device for providing audio output to the user, the hearing system is configured to perform a sound separation and to filter-out sounds by any non-activated entity, wherein in case an entity is activated, a sound of the entity is configured to be included in the audio output that is provided to the user by the hearing system, thereby enabling the user to hear the sound of the entity;
determining an angle between the user and the unknown entity;
capturing a noisy audio signal from an environment of the user;
generating, based on the angle, an enhanced audio signal that comprises a sound of the unknown entity, said generating the enhanced audio signal comprises applying the sound separation to extract a separate audio signal that represents the unknown entity from the noisy audio signal, wherein said generating the enhanced audio signal comprises incorporating the separate audio signal in the enhanced audio signal; and
outputting to the user, via the at least one hearing device, the enhanced audio signal.

23. The method of claim 22 further comprising:
generating, based on the angle, an acoustic signature of the unknown entity; and
extracting the separate audio signal based on the acoustic signature.

24. The method of claim 22 further comprising extracting the separate audio signal based on a direction of arrival of the sound of the unknown entity.

25. The method of claim 22, wherein said generating the enhanced audio signal uses one or more models to extract the separate audio signal from the noisy audio signal, the one or more models comprise at least one of: a generative model, a discriminative model, or a beamforming model.

26. The method of claim 22, wherein said determining that the user has the intention to hear the unknown entity is based on an analysis of activity of the user without an explicit instruction from the user, wherein the analysis of the activity of the user comprises at least one of: identifying a head movement of the user, or identifying a change in a sound direction of the user.

27. The method of claim 26, wherein the angle between the user and the unknown entity is determined based on an angle of the head movement or based on the sound direction.

28. The method of claim 22, wherein said determining that the user has the intention to hear the unknown entity is performed automatically without explicit user input, wherein the user indication comprises an automatic semantic analysis of a transcript of user speech.

29. The method of claim 22, wherein prior to said determining that the user has the intention to hear the unknown entity, the method comprises generating an acoustic signature of the unknown entity based on one or more dominant directions of arrival of sounds.

30. The method of claim 22, wherein said determining that the user has the intention to hear the unknown entity is based on explicit user input, the user input comprises one of: an indication of the angle between the user and the unknown entity, and an interaction of the user with the at least one hearing device.

31. The method of claim 22, wherein said determining that the user has the intention to hear the unknown entity is based explicit user input to a mobile device of the user, the explicit user input comprises a selection of a relative location between the user and the unknown entity via a map view that is rendered on the mobile device.

32. The method of claim 31 further comprising:
displaying the map view to the user via the mobile device, the map view depicting locations of one or more entities relative to a location of the mobile device;
receiving, via the mobile device, the selection of the relative location;
generating an acoustic fingerprint of the unknown entity based on a direction of arrival of the sound of the unknown entity; and
processing, based on the acoustic fingerprint, the noisy audio signal to extract the separate audio signal.

33. An apparatus comprising a processor and coupled memory, said processor being adapted to perform:
determining that a user has an intention to hear an unknown entity, the user utilizing a hearing system that includes at least one hearing device for providing audio output to the user, the hearing system is configured to perform a sound separation and to filter-out sounds by any non-activated entity, wherein in case an entity is activated, a sound of the entity is configured to be included in the audio output that is provided to the user by the hearing system, thereby enabling the user to hear the sound of the entity;
determining an angle between the user and the unknown entity;
capturing a noisy audio signal from an environment of the user;
generating, based on the angle, an enhanced audio signal that comprises a sound of the unknown entity, said generating the enhanced audio signal comprises applying the sound separation to extract a separate audio signal that represents the unknown entity from the noisy audio signal, wherein said generating the enhanced audio signal comprises incorporating the separate audio signal in the enhanced audio signal; and
outputting to the user, via the at least one hearing device, the enhanced audio signal.

34. The apparatus of claim 33, wherein said determining that the user has the intention to hear the unknown entity is based on a manual interaction of the user with the hearing device, wherein the sound of the unknown entity is identified based on a time of the manual interaction.
